(19) United States
(12) Patent Application Publication
(10) Pub. No.: US 2024/0166246 A1
(43) Pub. Date: May 23, 2024

(54) FREIGHT HANDLING SYSTEM AND METHOD

(71) Applicant: KACI INTERMODAL SYSTEMS, LLC, Dayton, OH (US)

(72) Inventor: Richard C Hathaway, Greenville, OH (US)

(73) Assignee: KACI INTERMODAL SYSTEMS, LLC, Dayton, OH (US)

(21) Appl. No.: 18/283,598

(22) PCT Filed: Mar. 22, 2022
(86) PCT No.: PCT/IB2022/052629

§ 371 Date: Sep. 22, 2023

Related U.S. Application Data
(60) Provisional application No. 63/164,858, filed on Mar. 23, 2021.

(51) Int. Cl. B61B 1/00; B61J 3/08

(52) U.S. Cl. CPC B61B 1/005; B61J 3/08

(57) ABSTRACT

A terminal is designed with a railcar staging area and a railcar transfer apparatus, the railcar transfer apparatus configured to move a railcar to and/or from railcar staging area. The terminal may be further designed with a terminal building where the railcar transfer apparatus is configured to move the railcar between the terminal building and the staging area. The staging area may be provided as two staging areas where the railcar transfer apparatus is configured to move the railcar between two staging areas. The railcar transfer apparatus may include automated railcar transfer device, bridge and shuttle.

### TECHNICAL FIELD

The subject matter relates to a freight transport. The subject matter may be related to handling of freight at a terminal. The subject matter may be related to transloading freight between different transportation modes.

### BRIEF DESCRIPTION OF THE DRAWINGS

The accompanying drawings are incorporated in and constitute part of the specification and illustrate various embodiments. In the drawings:

FIG. 1 illustrates a perspective view of a terminal;

FIG. 2A illustrates a partial perspective view of the terminal;

FIG. 2B illustrates a partial perspective view of the terminal;

FIG. 3 illustrates a partial elevation view of a terminal, particularly showing a railcar transfer bridge;

FIG. 4 illustrates a partial perspective view of the terminal, particularly showing operation of the railcar transfer bridge;

FIG. 5 illustrates a partial perspective view of the terminal, particularly showing operation of the railcar transfer bridge and a mover coupled to a railcar;

FIG. 6 illustrates an enlarged partial perspective view of the rail track transfer shuttle and the mover of FIG. 5;

FIG. 7 illustrates a perspective view of the railcar transfer shuttle with the railcar mover coupled to a railcar;

FIG. 8 illustrates a planar view of the railcar transfer shuttle;

FIG. 9 illustrates an elevation view of the railcar transfer shuttle of FIG. 8;

FIG. 10 illustrates a partial planar view of a railcar restraint with a restraint actuator being in a fully extended position and with the railcar being at a distance from the restraint coupler;

FIG. 11 illustrates a partial planar view of the railcar restraint of FIG. 10 with railcar coupler and restraint coupler being coupled to each other;

FIG. 12 illustrates a partial perspective view of the railcar restraint of FIG. 11;

FIG. 13 illustrates a partial perspective view of a railcar restraint with the restraint actuator being in a fully retracted position;

FIG. 14 illustrates a block diagram of a railcar restraint operation;

FIG. 15 illustrates a block diagram of the railcar restraint;

FIG. 16 illustrates an elevation view of the railcar dock bays;

FIG. 17 illustrates a partial perspective view of the railcar dock bays with doors being open;

FIG. 18 illustrates a partial perspective view of the terminal, particularly showing handling of the railcar at a terminal building with the mover and the railcar transfer bridge;

FIG. 19 illustrates a partial perspective view of the terminal, particularly showing handling of the railcar at a railcar staging area with a pair of railcar transfer bridges;

FIG. 20 illustrates a partial perspective view of the railcars at a terminal building;

FIG. 21 illustrates a partial perspective view of the terminal, particularly showing the railcar staging area and the mover;

FIG. 22 illustrates an elevation view of a railcar chassis supporting a freight container;

FIG. 23 illustrates a planar view of the railcar chassis of FIG. 22;

FIG. 24 illustrates an elevation view of the railcar chassis of FIGS. 22-23 with a smaller sized freight container;

FIG. 25 illustrates a partial perspective view of the terminal with a pair of freight containers mounted on a single chassis;

FIG. 26 illustrates a partial plan layout of a terminal with a single staging area for inbound and outbound railcars;

FIG. 27 illustrates an elevation view of the terminal of FIG. 26;

FIG. 28 illustrates a perspective view of the terminal of FIGS. 26-27;

FIG. 29 illustrates a perspective view of a terminal with a railcar transfer apparatus including an oval railway design with a railcar transfer arm;

FIG. 30 illustrates a perspective view of a terminal with a railcar transfer apparatus including an oval railway design with a railcar transfer arm and a linear railway design with a railcar transfer bridge;

FIG. 31 illustrates a plan view of the terminal of FIG. 30;

FIG. 32 illustrates a partial perspective view of a terminal;

FIG. 33 illustrates a plan view of the terminal of FIG. 32;

FIG. 34 illustrates a plan view of the terminal;

FIG. 35 illustrates a plan view of the terminal;

FIG. 36 illustrates a perspective view of the terminal;

FIG. 37 illustrates a partial perspective view of the terminal with a transfer carousel designed to rotate railcars;

FIG. 38 illustrates a partial perspective view of the terminal designed to handle refrigerated railcars and refrigerated tractor trailers;

FIG. 39 illustrates a partial perspective view of the terminal designed to handle refrigerated railcars and refrigerated tractor trailers;

FIG. 40 illustrates a partial perspective view of the terminal designed to handle refrigerated railcars and refrigerated tractor trailers;

FIG. 41 illustrates a partial perspective view of the terminal designed to handle railcars and tractor trailers in a tandem at one side of a terminal building;

FIG. 42 illustrates a perspective view of the terminal;

FIG. 43 illustrates a perspective view of the terminal;

FIG. 44 illustrates a diagrammatic plan view of a loading arrangement;

FIG. 45 illustrates an elevation view of an intermodal auto delivery dock design in an absence of a terminal building structure;

FIG. 46 illustrates an elevation view of an intermodal freight delivery dock design in an absence of a terminal building structure;

FIGS. 47A-47C illustrate elevation views of intermodal freight delivery terminals in an absence of a terminal building;

FIG. 48 illustrates a diagrammatic view of an intermodal network utilizing hub and spoke terminal concepts;

FIG. 49 illustrates a perspective view of a railcar coupler assembly with an automatic cut lever apparatus for automatically pivoting and maintaining a full open position of the coupler knuckle;

FIG. 50 illustrates a perspective view of a railway freight car coupler assembly with an automatic cut lever apparatus;

FIG. 51A illustrates a general schematic plan or layout view of an indexer;

FIG. 51B illustrates a partial schematic side elevational view of the layout of FIG. 51A, including parts of several railcars;

FIG. 52 illustrates a partial view of an indexer with a low dog addressing a bogey frame of a railcar truck; and

FIG. 53 illustrates a partial plan view of a railcar indexer with a high dog and a bogey frame sensing shown with a single railcar wheel truck assembly.

### DETAILED DESCRIPTION

Prior to proceeding to the more detailed description of the present subject matter, it should be noted that, for the sake of clarity and understanding, identical components which have identical functions have been identified with identical reference numerals throughout the several views illustrated in the drawing figures.

Features which are described in the context of separate embodiments may also be provided in combination in a single embodiment. Conversely, various features which are, for brevity, described in the context of a single embodiment, may also be provided separately or in any suitable subcombination. The Applicant hereby gives notice that new Claims may be formulated to such features and/or combinations of such features during the prosecution of the present Application or of any further Application derived therefrom.

It is to be understood that the singular forms “a,” “an,” and “the” include plural referents unless the context clearly dictates otherwise or expressly specified otherwise. Thus, for example, reference to “a component surface” includes reference to one or more of such surfaces.

For purposes here, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or,” “only one of,” or similar language; or (ii) two or more of the listed alternatives are mutually exclusive within the particular context, in which case “or” would encompass only those combinations involving non-mutually-exclusive alternatives.

For purposes here, the words “comprising,” “including,” “having,” and variants thereof, wherever they appear, shall be construed as open-ended terminology, with the same meaning as if the phrase “at least” were appended after each instance thereof.

The verb “may” is used to designate optionality/noncompulsoriness. In other words, something that “may” can, but need not.

Before elucidating the subject matter shown in the Figures, the present disclosure will be first described in general terms.

A terminal is provided to handle freight. The freight may be carried by a railcar. The terminal may be referred to as a freight handling terminal. The freight may be referred to as a material. The terminal may be referred to as a material handling terminal.

The freight may be palletized. Such freight may be carried by a box-type railcar. The box-type railcar may have one door at one end. The box-type railcar may have one door at each end. The box-type railcar may have a pair of doors at one end. The box-type railcar may have a pair of doors at each end. The box-type car may have a side door. The box-type railcar may have a combination of side and end doors.

The freight may comprise a liquid. Such liquid freight may be carried by a tanker-type railcar. The freight may be an agricultural product, for example such as a grain or corn. Such agricultural product freight may be carried by a hopper-type railcar. The freight may be coal. Such freight may be carried by a coal-type railcar. The freight may need to be refrigerated during transport. Such freight may be carried by a box-type railcar with a refrigeration apparatus at one end and a pair of doors at an opposite end.

The freight may be carried by a tractor trailer. Trailers of different types to carry specific freight, as described above.

The terminal may be designed with a railcar transfer apparatus configured to move the railcar. The railcar transfer apparatus may be configured or designed to move the railcar in a direction generally normal to a length of the railcar. The railcar transfer apparatus may be configured or designed to move the rail car in a direction along the length of the railcar, as the railcar will conventionally move on tail track. The railcar transfer apparatus may be configured or designed to move the railcar at least in a direction generally normal to a length of the railcar.

The railcar transfer apparatus may comprise rail tracks and a railcar transfer device and a railcar mover.

The rail tracks may comprise a pair of rail track segments disposed at a distance from each other to receive the railcar transfer bridge for a movement thereon. The rail tracks may comprise two pairs of rail track segments disposed at a distance from each other. The rail tracks may comprise more than two pairs of rail track segments disposed at a distance from each other.

The railcar transfer device may be provided as a railcar transfer bridge or a railcar transfer shuttle.

The railcar transfer bridge may be provided as a remotely controlled automated railcar transfer bridge. Such remotely controlled automated railcar transfer bridge may comprise two wheeled bogeys disposed at a distance from each other; a drive motor disposed on one wheeled bogey from the two wheeled bogeys; a platform attached to the two wheeled bogeys; two rail track portions disposed on the platform at a distance from each other to receive wheels of the railcar, a power source and a controller.

The wheeled bogey may include a pair of wheels connected therebetween by an axle. The wheel bogey may include two pair of wheels, each pair of wheels being connected therebetween by an axle. The platform supported on a pair of space-apart wheeled bogeys provides a shape of a bridge. A length of the platform is designed sufficient to receive the railcar connected to the railcar transfer device. The drive motor may be provided as two drive motors, each drive motors being coupled to a respective wheeled bogey. The drive motor(s) may be referred to as a propulsion designed to generate motive power sufficient to move the transfer bridge with a railcar coupled to a railcar transfer device. The power source may be a battery. The battery may be of a rechargeable type. The controller may be provided as a microprocessor-based controller. The controller may be provided as a programmable logic (PLC) controller. Such automated railcar transfer bridge being remotely operable to align the rail track portion with a rail track in the railcar staging area. The automated railcar transfer bridge may be operated autonomously based on a preselected logic algorithm programmed within the controller. The automated railcar transfer bridge may be operated by a person in a control room. When terminal building is provided, the automated transfer bridge may be programmed to move the railcar to a specific dock back from a plurality of dock bays. It will be understood that the automated railcar transfer bridge may be designed as a self-propelled transfer bridge.

The railcar transfer bridge may be provided as a driver operable transfer bridge. Such railcar transfer bridge may comprise two wheeled bogeys disposed at a distance from each other; a drive motor disposed on one wheeled bogey from the two wheeled bogeys; a platform attached to the two wheeled bogeys; two rail track portions disposed on the platform at a distance from each other to receive wheels of the railcar, a power source and a driver cab, the driver cab equipped with controls to move the transfer shuttle.

The wheeled bogey may include a pair of wheels connected therebetween by an axle. The wheel bogey may include two pair of wheels, each pair of wheels being connected therebetween by an axle. The platform supported on a pair of space-apart wheeled bogeys provides a shape of a bridge. A length of the platform is designed sufficient to receive the railcar connected to the railcar transfer device. The drive motor may be provided as two drive motors, each drive motors being coupled to a respective wheeled bogey. The drive motor(s) may be referred to as a propulsion designed to move the transfer bridge. The power source may be a battery. The battery may be of a rechargeable type. The controller may be provided as a microprocessor-based controller. The controller may be provided as a programmable logic (PLC) controller. The driver cab may be disposed on an upper surface of the platform. The driver cab may be attached to an edge of the platform. A length of the platform is designed sufficient to receive the railcar connected to the railcar transfer device. It will be understood that the automated railcar transfer bridge may be designed as a self-propelled transfer bridge.

The railcar transfer bridge may be referred to as a self-propelled mover.

The railcar transfer bridge may be sized to handle a specific type of a railcar. The railcar transfer bridge may be sized to handle an eighty-foot long box-type railcar. The railcar transfer bridge may be sized to handle a sixty-foot long box-type railcar. The railcar transfer bridge may be sized to handle well type railcar designed to carry forty-foot marine containers. In other words, the railcar transfer apparatus may use railcar transfer bridges of different lengths, each sized for a specific type railcar. The size refers to at least the length of the railcar transfer bridge and the motive power generated by drive motor(s). The railcar transfer apparatus may use railcar transfer bridges of identical sizes to standardize on one type of the railcar transfer bridge.

The railcar transfer bridge may be adapted with two or more rail track portions to handle two or more railcar movers and two or more railcars.

The railcar mover may be provided as an automated guided vehicle. Such automated guided vehicle may be designed as comprising two wheel sets; a drive motor coupled to one wheel set from the two wheel sets; a controller coupled to the drive motor; a power source coupled to the drive motor and to the controller; a frame supported on the two wheel sets; and a rail coupler with a coupler knuckle, the coupler knuckle extending outwardly from the frame.

The wheeled set may include a pair of wheels connected therebetween by an axle. The wheel set may include two pair of wheels, each pair of wheels being connected therebetween by an axle. The drive motor may be provided as two drive motors, each drive motors being coupled to a respective wheel set. The drive motor(s) may be referred to as a propulsion designed generate motive power sufficient to move the railcar mover. The power source may be a battery. The battery may be of a rechargeable type. The controller may be provided as a microprocessor-based controller. The controller may be provided as a programmable logic (PLC) controller. The rail coupler may be adapted with an optional coupler shank connected to the coupler knuckle. The rail coupler may comprise an optional remotely controlled cut lever operable to remotely unlock the coupler knuckle.

Such automated railcar mover may be remotely operable to couple to a railcar, move the railcar on the transfer bridge, move the railcar from the transfer bridge to a designated location and uncouple from the railcar. The automated railcar mover may be operated autonomously based on a preselected logic algorithm programmed within the controller. The automated railcar mover may be operated by a person in a control room. When terminal building is provided, the automated transfer bridge may be programmed to move the railcar to a specific dock back from a plurality of dock bays.

An optional driver cab may be mounted on the frame, the driver cab configured with controls to locally control operation of the railcar mover by a driver.

The railcar mover may be provided as a driver operated vehicle. Such railcar mover may comprise two wheel sets; a drive motor coupled to one wheel set from the two wheel sets; a power source coupled to the drive motor; a frame supported on the two wheel sets; a rail coupler with a coupler shank and a coupler knuckle extending outwardly from the frame; and a driver cab mounted on the frame, the driver cab configured with controls to control, by a driver, an operation of the railcar mover.

In either form, the railcar mover is designed to linearly move on the trail track on the surface of the railcar transfer bridge.

It will be understood that the automated railcar mover may be designed as a self-propelled mover. The railcar mover may be referred to as a railcar mule. The railcar mover may be referred to as a railcar transport device.

The railcar mover may be sized to handle a specific type of a railcar. The railcar mover may be sized to handle an eighty-foot long box-type railcar. The railcar mover may be sized to handle a sixty-foot long box-type railcar. The railcar mover may be sized to handle well type railcar designed to carry forty-foot marine containers. In other words, the railcar transfer apparatus may use railcar movers of different sizes, each sized for a specific type railcar. The railcar transfer apparatus may use railcar movers of identical sizes to standardize on one type of the railcar mover. The size of the railcar mover may include any one of a length, a height, a width, and a power. It would be understood that railcar mover of a greater motive power may be needed to handle the eight-foot box-type railcar as compared to the sixty-foot long box-type railcar.

Thus, in view of the above, the railcar transfer apparatus may be adapted with rail tracks disposed parallel to each other; the railcar transfer bridge that is designed with a propulsion to move railcar transfer bridge on the two parallel rail tracks, and two rail track portions; and a self-propelled mover designed to move a railcar onto and from the railcar transfer bridge. When a terminal building with dock bays is provided, the rail track segment on the surface of the railcar transfer bridge aligns with the rail track segment at each dock bay.

The railcar transfer apparatus may comprise rail tracks, as described above, a railcar transfer bridge, as described above, a railcar mover as described above, and a railcar transfer shuttle.

The railcar transfer shuttle is designed to move on a pair of spaced apart rail track segments.

The railcar transfer shuttle may be designed (configured) as an automated shuttle, the automated shuttle comprising four wheeled bogeys; a drive motor attached to one wheeled bogey from the four wheeled bogeys; a controller; a power source; a frame supported on four wheeled bogeys; and two rail track segments disposed, at a distance from each other, on the frame. More than one drive motor may be used. The drive motors(s) may be referred to as a propulsion designed to move the transfer shuttle. The power source may be a battery. The battery may be of a rechargeable type. The controller may be provided as a microprocessor-based controller. The controller may be provided as a programmable logic (PLC) controller.

The railcar transfer shuttle is designed (configured) to move between two pairs of rail tracks that are disposed parallel from each other so as to shuttle (transfer) the railcar between the pairs of parallel tracks. The railcar may be positioned on the railcar transfer bridge.

The railcar transfer shuttle may be sized to handle a specific type of a railcar transfer bridge. The railcar transfer shuttle may be sized to handle the railcar transfer bridge designed to receive an eighty-foot long box-type railcar. The railcar transfer shuttle may be sized to handle the railcar transfer bridge designed to receive a sixty-foot long box-type railcar. The railcar transfer shuttle may be sized to handle the railcar transfer bridge designed to receive well type railcar designed to carry forty-foot marine containers. In other words, the railcar transfer apparatus may use railcar transfer shuttles of different lengths, each sized for a specific type railcar transfer bridge. The railcar transfer apparatus may use railcar transfer shuttles of identical lengths to standardize on one type of the railcar transfer shuttle.

The railcar transfer shuttle may be adapted with additional rail track segments to handle two or more railcar transfer bridges.

In view of the above, the railcar transfer bridge and the railcar transfer shuttle are designed/configured to move a railcar and may be designed to only differ in size and motive power as the railcar transfer shuttle moves the railcar with a railcar mover positioned on the railcar transfer bridge.

The railcar transfer apparatus may comprise a curved-shaped area at one end of two pairs of parallel and straight rail tracks. When the railcar transfer apparatus comprises the curved-shaped area, the railcar transfer apparatus may comprise a self-propelled rotating transfer assembly mounted to rotate within the curved-shaped area.

The self-propelled rotating assembly may include a post, a platform with one end adapted to rotate about the post, a drive motor coupled, for example with gears, to the platform so as to rotate the platform about the post, a power source coupled to the drive motor, a controller to control rotation of the platform and two rail track segments mounted on the upper surface of the platform. In view of the above, the rotating transfer assembly is designed as an automated rotating transfer assembly. The rotating transfer assembly may have a shape of an arm. Two rail track segments allow the railcar transfer bridge to enter the platform prior to rotation when the two tracks are aligned with a pair of tracks within railcar transfer apparatus and exit the platform after the rotation when the two tracks are aligned with another pair of tracks within railcar transfer apparatus.

When the railcar transfer apparatus comprises the curved-shaped area, such curved-shaped area may be provided with a pair of curved rail track segments spaced apart sufficiently to align with the pair of straight and parallel rail track segments and receive the railcar transfer bridge thereon.

The railcar transfer apparatus may comprise an oval-shaped area with two pairs of parallel rail tracks disposed within the oval-shaped area and parallel to the long edges of the oval-shaped area.

When the railcar transfer apparatus comprises the oval-shaped area, the railcar transfer apparatus may comprise two self-propelled rotating transfer assemblies, as described above. Each self-propelled rotating transfer assembly is mounted at one end of the two pairs of rail tracks to rotate within a respective end curved-shaped area.

The pair of self-propelled rotating transfer assemblies may improve efficiency and rate of the railcar transfer between the pairs of parallel rail tracks.

When the railcar transfer apparatus comprises the oval-shaped area, the railcar transfer apparatus may comprise two pairs of curved rail track segments spaced apart sufficiently to align with the pair of straight and parallel rail track segments and receive the railcar transfer bridge thereon. Each pair of curved rail track segments will be positioned at one end of the parallel and straight rail track segments.

The railcar transfer apparatus may comprise a transfer bridge staging area. Such transfer bridge staging area will comprise a pair of rail track segment connected to the main rail track segments. The length of the pair of rail track segments in the transfer bridge staging area depends on a particular application. In a non-limited example, the length may depend on the number of dock bays in the terminal building and/or a number of railcars to be transferred within a specific period of time.

In application that is related to handling refrigerated railcars, the railcar transfer terminal may be designed with an automated rotating transfer carousel with two rail track segments on a top surface. The purpose of the automated rotating carousel is to rotate the refrigerated railcar 180 degrees for positioning a non-airconditioned end of such refrigerated railcars at the dock bay door. The automated rotating transfer carousel may be designed as a self-propelled rotating transfer carousel in view of the above. The automated rotating transfer carousel may be positioned at an end of the railcar staging area. The automated rotating transfer carousel may be positioned adjacent the parallel rail track segments. In other words, the parallel rail track segments will be disposed between the railcar staging area and the automated rotating transfer carousel.

The transfer carousel, as described above, may be also used with a non-refrigerated railcar. The transfer carousel may be used in applications where two freight containers are mounted in tandem on a single railcar, for example such as a rail chassis or on a flatbed-type railcar. Each freight container may be a marine type freight container (or a marine container) with a door at one end. When the terminal is designed to handle such marine containers positioned in tandem on the railcar, each container will have its end door positioned at a respective end of the rail railcar. The transfer carousel may be then used to rotate the railcar after one freight container had been loaded or unloaded so as to position an end door of the other freight container at the dock bay for loading the freight thereinto or unloading the freight therefrom. After rotation, the railcar may be positioned at the same dock bay used for unloading the first freight container. After rotation, the railcar may be positioned at a different dock bay. The terminal may be designed with a railcar staging area. In this application, the railcar transfer apparatus will be configured to move the railcar to and/or from the railcar staging area.

The railcar staging area may utilize portions of land. The railcar staging area includes a railway track. The railway track may be laid on a ground level. The rail track may be elevated above the ground level. The rail track may be disposed below ground level. The rail track may be provided as a dead-end track where the railcar may arrive from one direction only and depart in the same direction. The rail track may be provided as a through track where the railcar may arrive from two directions and depart in two directions.

The railcar staging area may be designed with a first rail track and a second rail track disposed parallel to each other. The first and second rail tracks may be disposed adjacent to each other. The first and second rail tracks may be disposed remotely from each other, for example at opposite ends of a terminal building, as described below. Either one of the first and second rail tracks may be provided as a dead-end track where the railcar may arrive from one direction only and depart in the same direction. Either one of the first and second rail tracks may be provided a through track where the railcar may arrive from two directions and depart in two directions.

The railcar staging area may be designed with multiple rail tracks. The multiple rail tracks may be laid parallel to each other. The multiple rail tracks may be disposed adjacent to each other. One portion of the rail tracks may be disposed remotely or at a distance from another portion of rail tracks. One portion of the rail tracks may be separated by a terminal building from another portion of the rail tracks.

The rail car staging area may be adapted with an optional railcar indexer. The railcar indexer may eliminate a need for a locomotive or a mule to advance a single or a plurality of railcars within the staging area. The railcar indexer may be operated from a pendant or from an operator's booth.

The railcar indexer may be designed with a plurality of dog carriages, serially aligned in fixed spaced relation. Each carriage carries a railcar axle-engaging dog and a railcar wheel sensor and a hydraulic operating system including a hydraulic cylinder for moving the plurality of dog carriages in unison in a reciprocating ratcheting manner and operating said axle-engaging dogs. A control system may be provided to coordinate the operation of the railcar indexer.

The railcar indexer may also include a pair of spaced trackside railcar movers positioned outside and parallel to the rails of a rail track. Each railcar mover may include a spaced trackside guideway located next to one of the railway rails, a plurality of spaced connected dog carriages mounted for operation together in the guideway, each dog carriage carrying a pusher dog mounted on the carriage, a reciprocating hydraulic cylinder associated with the plurality of spaced, connected dog carriages. A hydraulic power unit may be connected to operate each of the cylinders individually or together and a control system may be associated with the power unit for controlling the operation of the railcar indexer. The railcar indexer may be used as a railcar progressor.

The railcar indexer may be designed with a carriage-mounted mechanical bogey frame detecting and dog operating systems. The systems may include a pair of dog carriages mounted for operation in spaced trackside guideways, each dog carriage including a pusher dog mounted on each dog carriage, each dog having an associated hydraulic dog cylinder for operating the dog; and a bogey frame detecting system mounted on each of the dog carriages for use in controlling the operation of each of the dogs. The bogey frame detecting system may be designed with detecting assembly including a crank arm-mounted follower positioned to be deflected by an underside of an encountered bogey frame, a spring-biased, normally closed hydraulic valve device connected to control each hydraulic dog cylinder for controlling raising of a connected dog, wherein an opening of a valve is determined by a deflection of a follower in a first direction, and a resilient linkage assembly between the follower and the valve for transmitting sufficient force to open the valve.

More than one railcar indexer may be provided within a single track.

The railcar indexer, as described above, may be used in an alternative to the railcar mover, where the railcar indexer is mounted on the railcar transfer bridge.

The railcar staging area may be provided as two distinct railcar staging areas. Each distinct area may be designed to receive the railcar from one direction only. Each distinct railcar staging area may be designed to receive the railcar from two directions. Two distinct staging areas may be configured so that one staging area receives the railcar from one direction and another staging area receives the railcar from a different direction.

The railcar staging area may be used to handle incoming railcars. The railcar staging area may be used to handle outgoing railcars. The railcar staging may be used to handle both the incoming railcars and the outgoing railcars. In other words, the railcar staging area may comprise a first railcar staging area and a second railcar staging area.

The railcar staging area may include an intermediate railcar staging area separated from the staging area by a railcar transfer apparatus.

The terminal may be configured or designed with a terminal building. The terminal building may be designed with a hollow interior and a plurality of dock bays. The dock bays may be provided along a wall of the terminal building. The dock bays may be provided along two opposite walls of the terminal building. In other words, the terminal building may be designed with a first plurality of dock bays provided along a first wall of the terminal building and with a second plurality of dock bays provided along a second wall of the terminal building. The second wall may be disposed opposite the first wall. The second wall may be disposed adjacent the first wall. The terminal building may have more than two walls with dock bays.

The terminal building may be further designed with rail track segments, where each rail track segment extends outwardly from a respective dock bay. In this configuration, the terminal building may be designed to receive the railcar at each dock bay. The terminal building may be further designed with a rail track segment extending outwardly from some dock bays. In this configuration, the terminal building may be designed to receive the railcars at some dock bays and receive tractor trailer at remaining dock bays.

The terminal building may be referred to as a warehouse. The terminal building may be referred to as a transloading facility. The terminal building may be a portion of a manufacturing facility used for loading final product or unloading row material and/or subcomponents. The portion does not have to be physically connected to the manufacturing facility. The terminal building may be further designed with rail track segments, each rail track segments from the rail track segments connecting a respective dock bay to the railcar transfer terminal.

In view of the above, the terminal may be designed with a terminal building that has a hollow interior and a plurality of dock bays along one or two walls of the terminal building; rail track segments, each rail track segments from the rail track segments connecting a respective dock bay to the railcar transfer apparatus; a first rail track at one end of the terminal building; and a second rail track at an opposite end of the terminal building; where the terminal is provided in a railcar exchange with each of the terminal building, the first rail track and the second rail track.

The dock bay may be designed to include any one of a dock door, a dock seal, a dock shelter, a dock light, edge of dock leveler, and any combinations thereof. The dock bay may be referred to as a loading dock bay. The dock bay may be referred to as an unloading dock bay. In other words, the dock bay may be used to load material into a railcar or unload the material from the railcar.

The terminal building may be further equipped with optional railcar restraints. When provided, the railcar restraint is installed at a dock bay and is designed to prevent an undesirable creep of the railcar, parked at the dock bay, away from the dock bay.

The railcar restraint may be configured as a rail coupler and a linear actuator connected to the railway coupler. The rail coupler may comprise a coupler knuckle and may further comprise a coupler shank connected to the coupler knuckle. The rail coupler may comprise a coupler shank; a coupler head having a knuckle side and a guard arm side; a knuckle pin mounted within the coupler head; and a coupler knuckle which is mounted for independent rotation on the knuckle pin.

The coupler knuckle is designed to couple to a coupler knuckle on the railcar. In other words, the coupler knuckle within the railcar restraint may be identical to the coupler knuckle on the railcar. The linear actuator may be connected directly to the coupler knuckle. The linear actuator may be connected directly to the coupler shank on couplers equipped with such coupler shanks. The actuator is designed to move the rail coupler in a linear direction. The linear actuator may be one of a pneumatic cylinder, a hydraulic cylinder, and an electric actuator. A draft gear may be mounted mediate the rail coupler and the linear actuator. The linear actuator may be operated under power. The linear actuator may be operated manually through a crank and linkage. Powered linear actuator may be designed with a manual override. The rail coupler may be adapted with a remotely controlled cut lever apparatus operable to remotely lock and unlock the coupler knuckle with a coupler knuckle on the railcar.

The railcar restraint may be provided as the above described railcar indexer being mounted within the rail track segments disposed in a distance between a wall of the terminal building and the railcar transfer apparatus.

The cut lever apparatus may automatically actuate a lock lift assembly to either lock or unlock a coupler knuckle. The cut lever apparatus may include a cylinder having a piston disposed therein. A bracket member is attachable to the rail coupler to support the cylinder. A linkage may be connected to the piston of the cylinder and the lock lift assembly to convert a lateral motion of the piston to a curvilinear motion of the lock lift assembly to either lock or unlock the coupler knuckle. A valve may be connected to the cylinder for communicating a pressurized fluid to the cylinder when a signal is sent to the valve and preventing pressurized fluid from entering the cylinder in an absence of the signal. Pressurized fluid in the cylinder is vented to atmosphere when the valve shuts off supply of pressurized fluid thereto.

The cut lever apparatus may comprise a coiled torsion spring capable of continuously exerting a force; an attachment between the coiled torsion spring and a portion of a coupler head; and a connection between an arm of the coiled torsion spring and the coupler knuckle, the connection generating a torque on the coupler knuckle to pivot and maintain the full open position of the coupler knuckle.

The railcar indexer may be installed on the railcar transfer bridge and replace the railcar mover.

The railcar restraint may be designed as a rail track segment inclined downwardly from the railcar transfer apparatus. The railcar restraint may be designed as a wheel chock. The wheel chock may be manually placed to contact a wheel in a bogey of the railcar and then is removed to allow movement of the railcar. The wheel chock may be adapted with an actuator to move the chock in a first direction to contact a wheel in a bogey of the railcar and move the chock in a second direction to break a contact with the wheel.

The railcar restraint may be designed as an actuator with a movable part contacting a portion of the railcar after such railcar is moved to a dock bay. The movable part may contact an axle of the wheeled bogey on the railcar. Such actuator may be mounted between the rail track segments extending from the dock bay. The actuator may be provided as a linear or as a rotary actuator.

In view of the above, the actuator-type railcar restraint may be also installed in the railcar staging area to temporarily restrain movement of the railcar during coupling of the railcar transfer device to the railcar or uncoupling of the railcar from an adjacent railcar within the train consist. Similarly, the actuator-type railcar restraint may be employed within the outgoing railcar staging area as each railcar is being added to the train consist and being coupled to the railcar closest to the railcar transfer apparatus. Use of actuator-type railcar restraint may eliminate a need for manual coupling and uncoupling of the railcars, particularly when the railcar transfer device is equipped with remotely controlled automatic cut lever apparatus. Use of actuator-type railcar restraint may eliminate use of handbrakes to temporarily prevent undesirable movement of a standing railcar.

It would be understood that more than one actuator-type railcar restraint may be installed in a series with each other. Such railcar restraints may be spaced along a length of the train consist. The railcar restraints may be installed at each location where the railcar will be located within the staging area or may be installed to skip one or more railcars.

In application that is related to transloading marine container between the railcar and a container chassis pulled by a truck cab (tractor), the terminal may be adapted with an overhead gentry-type crane. The railcar and the container chassis may be aligned, during transloading, therebetween along a length of the marine container so that the overhead gentry-type crane only travels in a linear direction.

The terminal may be configured with a single railcar transfer apparatus in a rail communication with the railcar staging area. The terminal may be configured with two railcar transfer apparatuses, each in a rail communication with a respective railcar staging area. The terminal may be used to handle railcars of different sizes. In this application, each railcar transfer apparatus from the two railcar transfer apparatuses may be configured (size, motive power, etc) to handle a specific size or type of the railcar or a group of railcars. One (first) railcar transfer apparatus may be configured to handle marine containers from a marine port and the other one (second) railcar transfer apparatus may be configured to handle eight-foot box-type railcars. This terminal may be then used to transload the freight from marine containers into the eight-foot box-type railcars or transload the freight from the eight-foot box-type railcars into the marine containers to be returned to the marine port.

The terminal does not have to be provided with a terminal building. The terminal may be designed to load and unload railcars at a ground level by providing a surface, with a rail track, that is recessed (offset) from a ground level surface with a rail track or from a raised platform with a rail track. In this design, the railcar may be be positioned to be loaded/unloaded from one end.

In view of the above, the terminal may be referred to as a freight handling system. In view of the above, the terminal may be configured or designed to handle box-type railcars having end door at one or two ends.

The terminal, as described above, may be designed to operate in a variety of operational modes or operational methods.

A method may include the steps of moving, with a self-propelled transfer bridge and a self-propelled mover, a railcar from a staging area to a dock bay. Then, transloading freight between the railcar and another railcar, each positioned at a respective dock bay. And, moving each of the railcar and another railcar from a respective dock bay. The railcar and the another railcar may be moved back to the same train consists that they were removed from or may be moved to form a different train consist. The method may comprise using a box-type railcar with an end door and positioning the box-type railcar normal to a wall of the terminal building.

A method may include the steps of moving, with a self-propelled transfer bridge and a self-propelled mover, a railcar from a staging area to a dock bay. Then, transloading freight between the railcar and one of a trailer and another railcar, each positioned at a respective dock bay. And, moving each of the railcar and the tractor trailer from a respective dock bay. The railcar may be moved back to the same train consist that it was removed from or may be moved to form a different train consist. The method may comprise using a box-type railcar with an end door and positioning the box-type railcar normal to a wall of the terminal building. The method may be achieved by moving the railcar from one train consist to another train consist without off-loading freight at a terminal building. In this method, railcars in a train consist arriving from one destination are being segregated into different train consists to deliver freight to different destinations.

A method may include a step of using hub and spoke terminal buildings. The hub terminal building may be applicable to a high volume freight destination, for examples such as a marine port or a major inland railyard. The spoke terminal building may be applicable to rail yards or terminal buildings in smaller cities or smaller destinations. The hub terminal building may be also referred to as a consolidation yard where railcars coming from various low-volume freight loading/unloading destinations are removed from an original train consist and are moved/assembled, with the railcar transfer apparatus, into a single consist for delivery to another high-volume freight loading/unloading destination. In other words, the physical terminal building may not be needed in such application.

When the terminal building is a portion of a manufacturing facility, the method may be directed to delivering freight from an originating freight facility directly to the manufacturing facility without a need for an intermediate transloading operation. The method may include the steps of loading freight into a box-type railcar at the freight originating facility, moving the railcar to a staging area adjacent the manufacturing facility, moving the railcar with a railcar transfer apparatus to a dock bay within the manufacturing facility. The method may include loading the freight into the box-type railcar through an end door and positioning the railcar at a dock bay of the manufacturing facility to unload the freight through the end door. The freight originating facility may be a hub terminal. The freight originating facility may be a spoke terminal. The freight originating facility may be a marine terminal.

When the terminal building is a portion of a manufacturing facility, the method may be directed to delivering freight directly from the manufacturing facility to the freight destination facility without a need for an intermediate transloading operation. The method may include the steps of loading freight into a box-type railcar at the manufacturing facility, moving the railcar with a railcar transfer apparatus from a dock bay within the manufacturing facility to a staging area adjacent the manufacturing facility, and transporting the box-type railcar to the freight destination facility. The method may include loading the freight into the box-type railcar through an end door. The freight destination facility may be a hub terminal. The freight destination facility may be a spoke terminal. The freight destination facility may be a marine terminal.

When the terminal building is a warehouse, the method may be directed to delivering freight from an originating freight facility directly to warehouse without a need for an intermediate transloading operation. The method may include the steps of loading freight into a box-type railcar at a freight originating facility, moving the railcar to a staging area adjacent the warehouse, moving the railcar with a railcar transfer apparatus to a dock bay within the warehouse. The method may include loading the freight into the box-type railcar through an end door and positioning the railcar at a dock bay of the warehouse to unload the freight through the end door. The method may further include a step of loading the freight unloaded from the railcar into a tractor trailer. The method may include a step of positioning the trailer at a dock bay along a wall being opposite to a wall of the warehouse having a dock bay designed to receive an end of the railcar. The method may further include a step of unloading the freight from a trailer and loading the freight into the box-type railcar. The method may further include a step of transloading the freight between the railcar and a tractor trailer. The freight originating facility may be a hub terminal. The freight originating facility may be a spoke terminal. The freight originating facility may be a marine terminal. In view of the above, a reversed method may be used to deliver the freight from the ware house directly to the destination facility without a need for an intermediate transloading operation.

A method may include a step of positioning a length of the railcar perpendicular (normal) to a wall of the terminal building. In this orientation, a greater number of railcars may be loaded and unloaded simultaneously through end doors within a terminal area as compared to loading and unloading railcars through a side door.

A method may include a step of positioning a length of the trailer perpendicular (normal) to a wall of the terminal building.

A method may include the steps of loading a marine container onto a railcar; moving the railcar with the marine container to a first terminal; moving the railcar with a railcar transfer apparatus from a staging area to a dock bay; transloading the freight into a box-type railcar through an end door thereof; moving the box-type railcar to a second terminal; and unloading the freight through the end door at the second terminal. The method may further include a step of transloading the freight, at the second terminal, into a trailer. The method may further include a step of transloading the freight, at the second terminal, into another railcar. The step of moving the railcar may comprise coupling railcars with marine containers thereon into a train consist at a marine terminal and moving the railcars in such train consist from the marine terminal. This step may eliminate a need for loading the marine container onto a truck-trailer chassis and moving the marine connector with a truck (tractor). Thus, this step may reduce pollution by eliminating a diesel-powered truck (tractor). This step may eliminate congestion at a marine terminal by at least reducing if not eliminating trucks.

A method may include a step moving, with a railcar transfer apparatus configured to move a railcar at least in a direction generally normal to a length of the railcar, the railcar from one train consist in one staging area directly to another staging area to form another train consist. The method, employing the railcar transfer apparatus as described above, may improve throughput of reconfiguring train consists at a rail yard. The method, employing the railcar transfer apparatus as described above, may at least minimize damages to a railcar by eliminating a free-moving railcar let go along a rail track branch as is associated with a conventional train consist configuration method.

Now in a reference to the drawings.

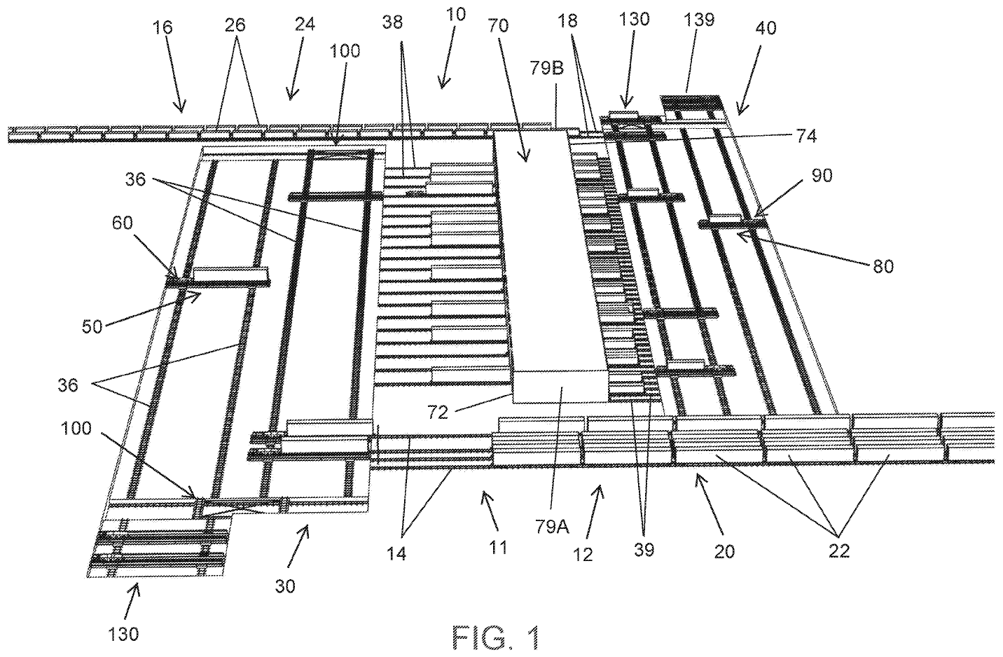

FIG. 1 illustrates a perspective view of a terminal 10. The terminal 10 is illustrated with two staging areas, 12 and 16. The staging area 12 is illustrated with rail tracks 14 on a ground level 11. Train consist 20 includes railcars 22. Staging area 16 is illustrated with rail tracks 18 on a ground level 11. Train consist 24 includes railcars 26. Railcar 22 is illustrated in various figures as having a different size than the railcar 26. The railcar 22 may be of an identical size to the size of the railcar 26.

FIG. 1 also illustrates a railcar transfer apparatus 30 and a railcar transfer apparatus 40 that are disposed adjacent and at a distance from a respective (side) wall of a terminal building 70. As illustrated, the wall 74 is parallel to the wall 72. The railcar transfer apparatus 30 is illustrated as being disposed adjacent a wall 72, that may be referred to as a first wall or one wall. The railcar transfer apparatus 40 is illustrated as being disposed adjacent a wall 74, that may be referred to as a second wall or another wall. The terminal building is further denoted with ends 79A and 79B.

FIG. 1 further illustrates automated railcar transfer bridges 50 and 80, railcar movers 60 and 90, railcar transfer shuttles 100 and 120 and optional railcar transfer bridge staging areas 130 and 139 for railcar transfer bridges 50 and 80 respectively.

The railcar transfer apparatus 30 may be designed to handle railcars of different size and/or type than the railcar transfer apparatus 40. The railcar transfer apparatus 30 may be designed to handle railcars of identical size and/or type as the railcar transfer apparatus 40.

The railcar transfer apparatus 30 is illustrated in FIG. 1 with two pairs of rail tracks 36 (four total rail tracks), disposed parallel to each other. Each rail track comprises two rails disposed at a distance from each other to mate with wheels of the railcar transfer bridge 50. The railcar transfer apparatus 30 is further illustrated in FIG. 1 as comprising two railcar transfer shuttles 100, each mounted at a respective end of the rail tracks 36.

Each railcar transfer shuttle 100 is mounted to move between the two pairs of rail tracks 36 so as to move the railcar transfer bridge 50 between the two pairs of rail tracks 36.

Two pairs of rail tracks 36 and two railcar transfer shuttles 100 increase throughput of the railcar transfer apparatus 30 as the railcar transfer bridge 50 without the railcar thereon can be transferred, by one railcar transfer shuttle 100 from one pair of the rail tracks 36 closest to the terminal building 70 to the adjacent pair of rail tracks 36 and returned to the same pair of the rail tracks 36 by another railcar transfer shuttle 100 for positioning a the staging area 12 so as to receive next available railcar 22 in the staging area 12 closest to the railcar transfer apparatus 30.

However, the railcar transfer apparatus 30 can be configured with only one pair of rail tracks 36 and without railcar transfer shuttles 100.

The quantity of railcar transfer bridges 50 and railcar movers 60 may depend on the desired throughput of the railcar transfer apparatus 30 and/or the quantity of dock bays at the terminal building 70 or the quantity of track segments 38 if the terminal building 70 is not provided.

Similar configuration may apply to the railcar transfer apparatus 40.

The terminal building 70 may be an optional feature of the terminal 10. Furthermore, the terminal building 70 may be provided in a shape different than a rectangular shape illustrated in FIG. 1. Dock bays may be also disposed within ends 79A and/or 79B.

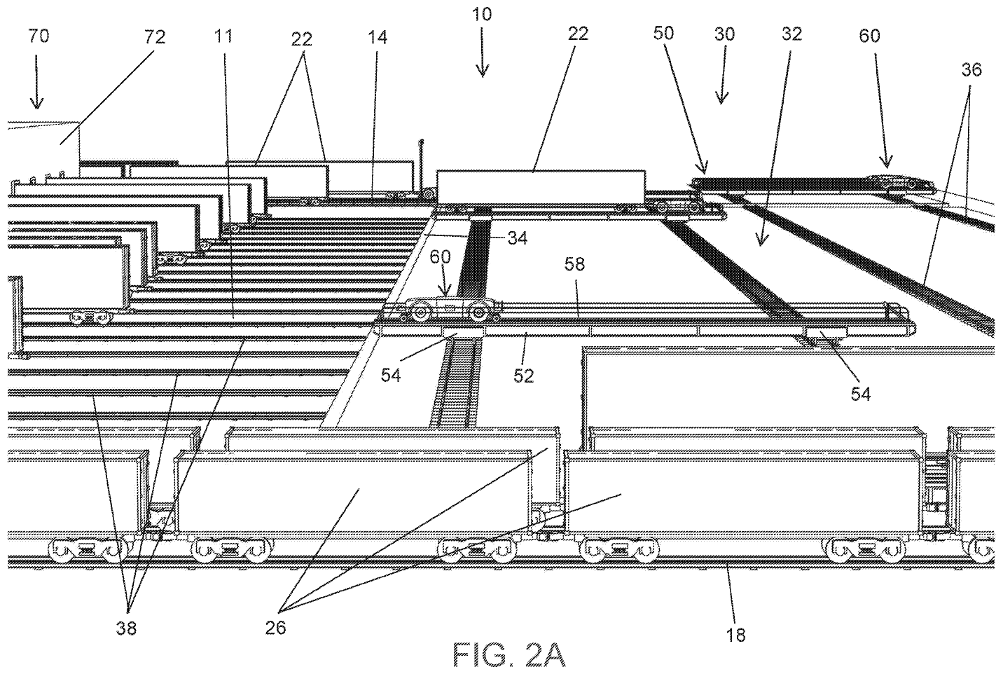

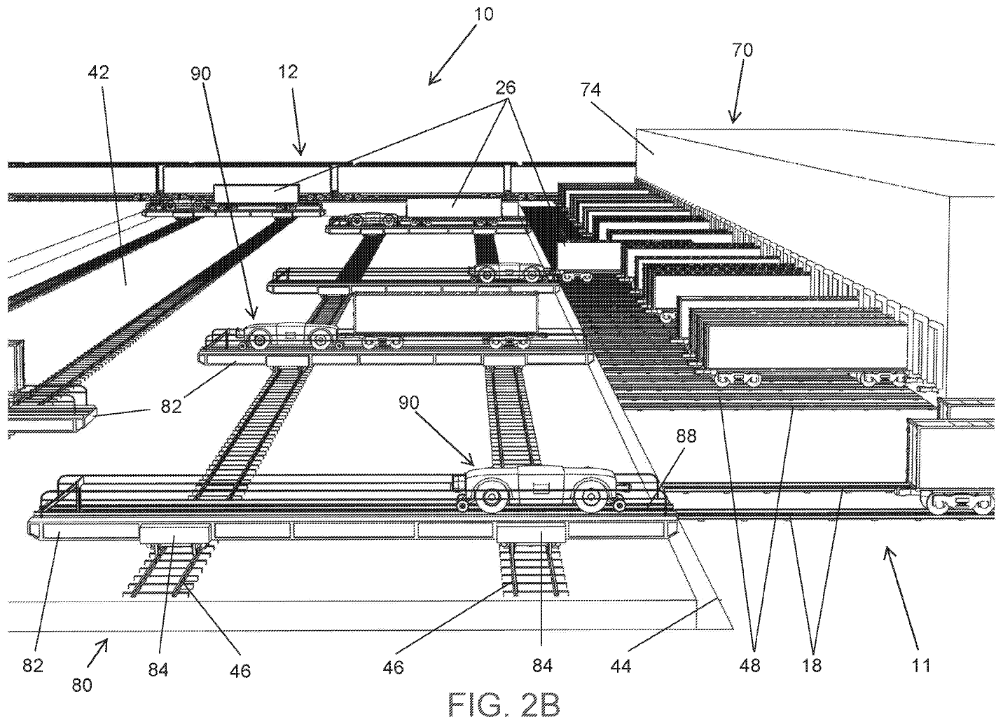

FIG. 2A illustrates a partial perspective view of a terminal 10 with the railcar transfer apparatus 30 to move rail cars 22 between staging area 12 and the terminal building 70. The railcar transfer apparatus 30 includes a surface 32 that is offset downwardly from the ground level 11. The offset surface 32 defines a vertical edge 34. Two pairs of rail tracks 36, 36A are disposed in a spaced apart relationship with each other along and parallel to the vertical edge 34. A plurality of parallel rail track segments 38 extend from the vertical edge 34 to the wall 72 of the terminal building 70, partially illustrated. The railcar transfer apparatus 30 also includes a railcar transfer bridge 50. The railcar transfer bridge 50 includes a frame 52 supported on two wheeled bogeys 54. A rail track segment 58 is positioned on a top surface of the frame 52. FIG. 2A also illustrates a railcar mover 60 that is designed to move a railcar 22 onto and from the railcar transfer bridge 50. The railcar mover 60 is designed to move on the rail track segment 58. The two pairs of rail tracks 36 may be provided as a single pair of rail tracks 36.

FIG. 2B illustrates a partial perspective view of a terminal 10 with the railcar transfer apparatus 40 to move rail cars 26 between staging area 16 and the terminal building 70. The railcar transfer apparatus 40 includes a surface 42 that is also offset downwardly from the ground level 11. The offset surface 42 defines a vertical edge 44. Two pairs of rail tracks 46 are disposed in a spaced apart relationship with each other along and parallel to the vertical edge 44. A series of parallel track segments 48 extend from the vertical edge 44 to the wall 74 of the terminal building 70, partially illustrated. The railcar transfer apparatus 40 also includes a railcar transfer bridge 80. The railcar transfer bridge 80 includes a frame 82 supported on two wheeled bogeys 84. A rail track segment 88 is positioned on a top surface of the frame 82. FIG. 2B also illustrates a self-propelled railcar mover 90 that is designed to move a railcar 26 onto and from the railcar transfer bridge 80. The mover 90 is designed to move on the rail track segment 88. The railcar mover 90 may be designed identical to the railcar mover 60.

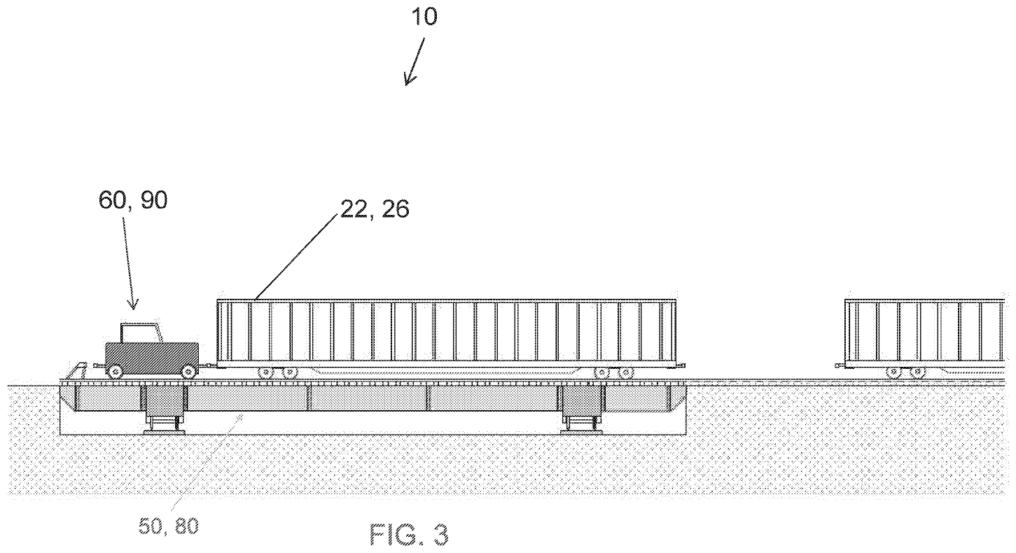

FIG. 3 illustrates a partial elevation view of the terminal 10, particularly illustrating railcar transfer bridges 50, 80 and railcar movers 60, 90.

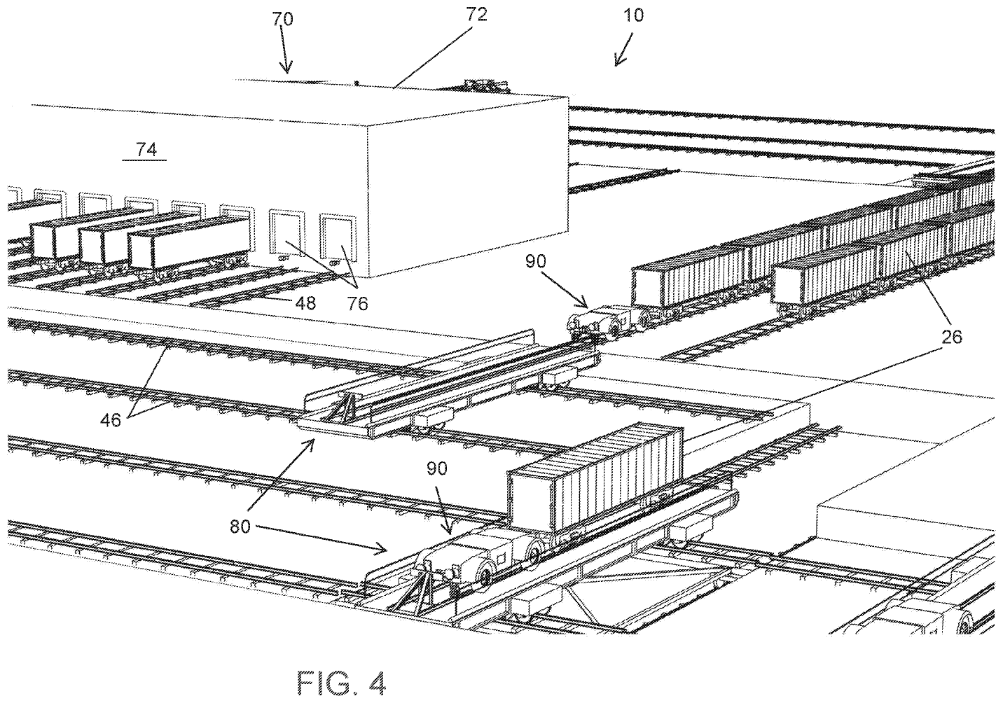

FIG. 4 illustrates a partial perspective view of a terminal 10, particularly showing operation of the railcar transfer bridge 80 and the railcar movers 90. Dock bays 76 are also illustrated along the wall 74.

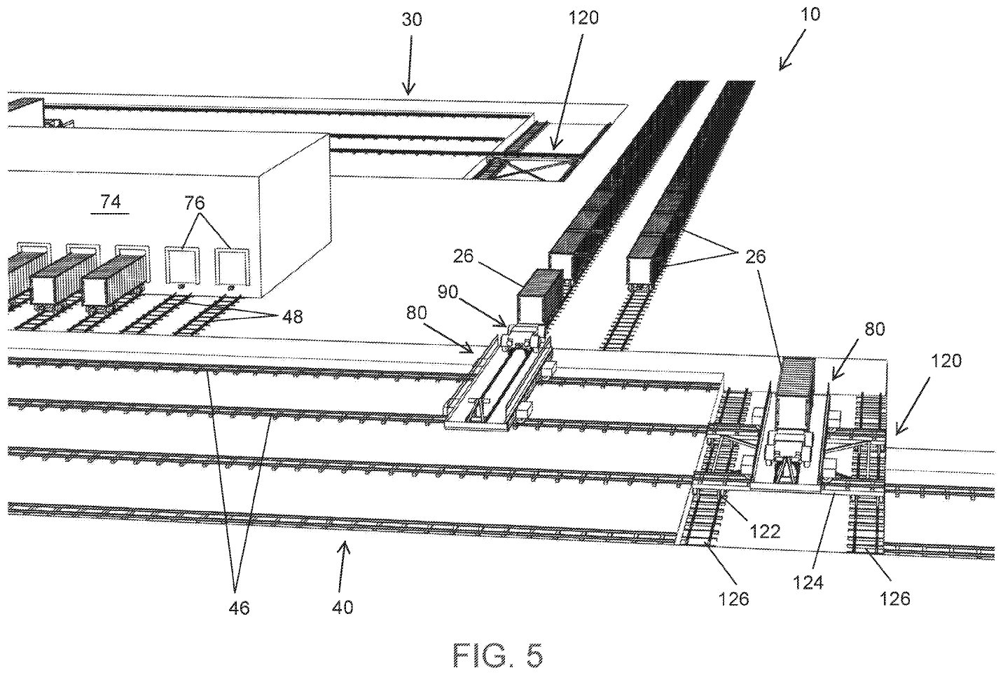

FIG. 5 illustrates a partial perspective view of a terminal 10, particularly showing operation of the railcar transfer bridge 80, the railcar mover 90 coupled to a railcar 26 and a rail car transfer shuttle 120 with a frame 124 mounted on wheeled bogeys 122 that are moving on a pair of spaced apart rail track segments 126.

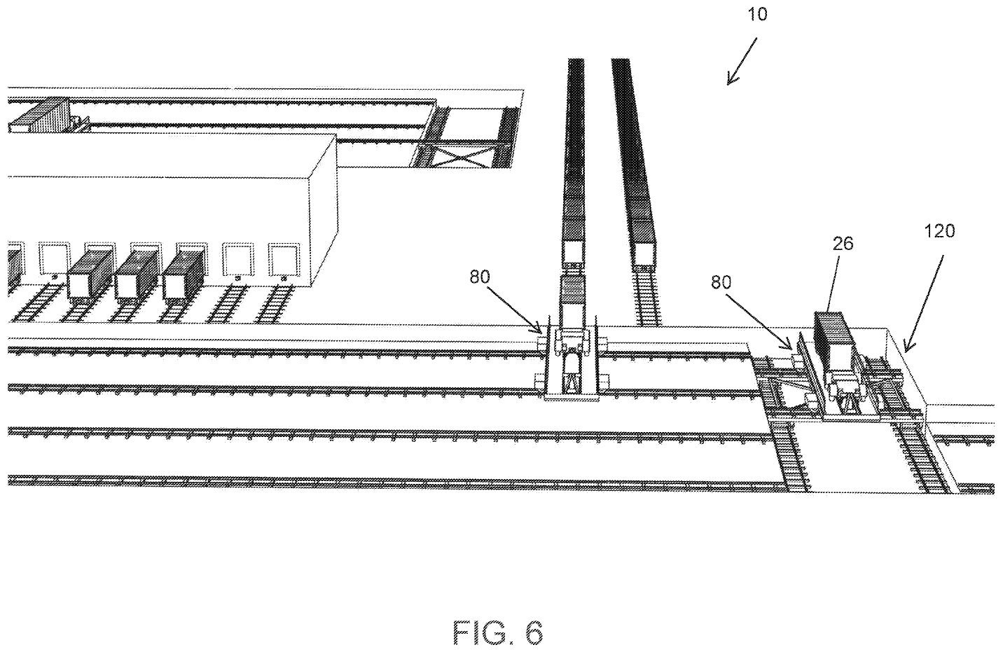

FIG. 6 illustrates a partial perspective view of the rail car transfer shuttle 120 of FIG. 5. The railcar transfer bridge 80 and the railcar mover 90 are also illustrated.

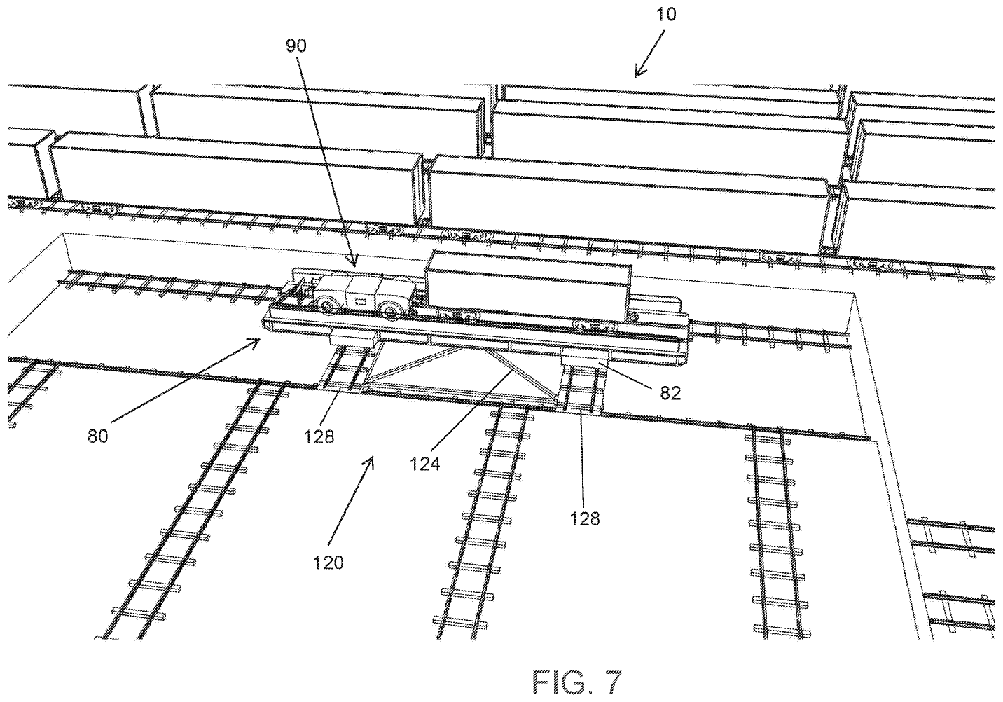

FIG. 7 illustrates an enlarged partial perspective view of the rail railcar transfer shuttle 120 of FIG. 5 with the pair of rail track segments 128. The railcar transfer bridge 80 and the railcar mover 90 are also illustrated.

FIG. 8 illustrates a planar view of the rail car transfer shuttle 100, 120.

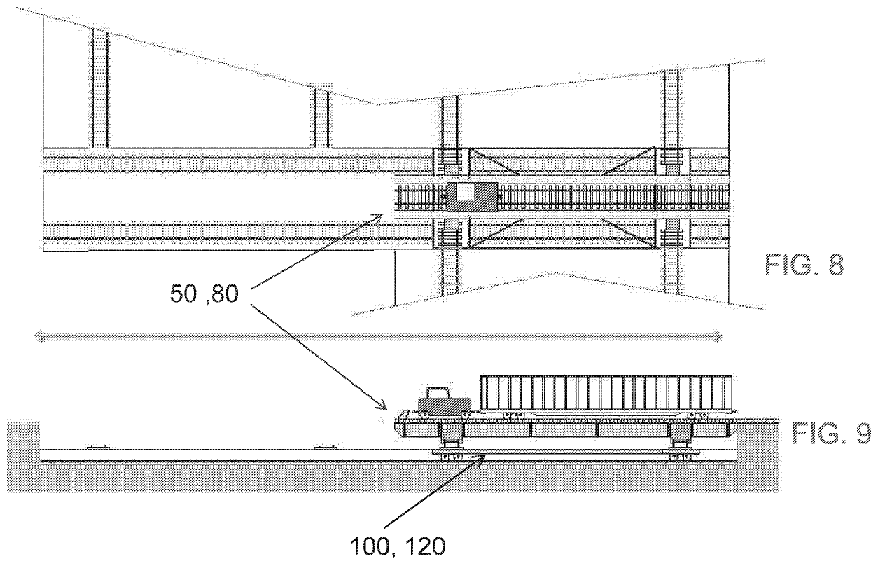

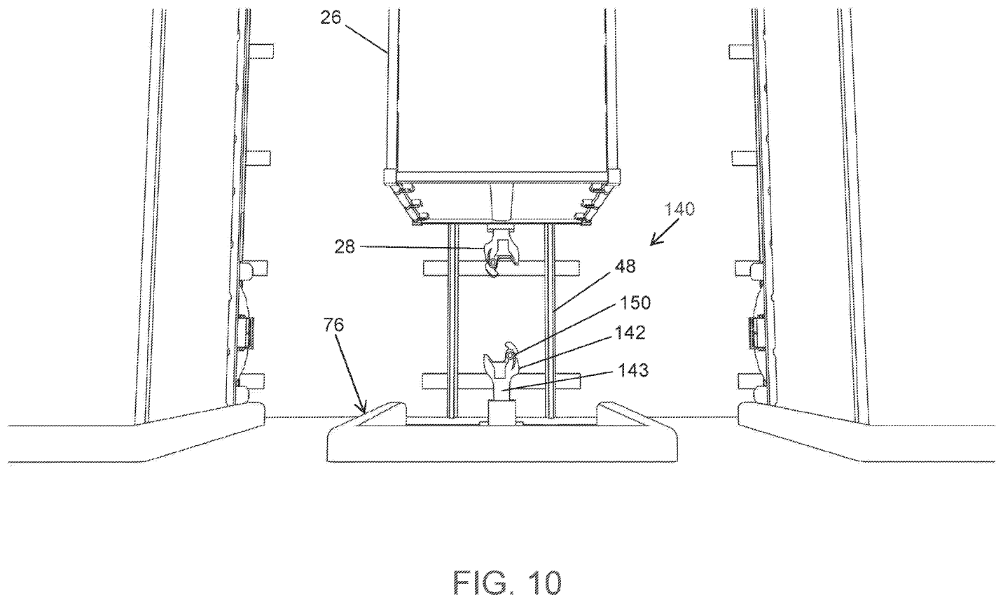

FIG. 9 illustrates an elevation view of the rail car transfer shuttle 100, 120 of FIG. 8. FIG. 10 illustrates a partial planar view of a railcar restraint 140 with a rail coupler knuckle 142 being in a fully extended position from the dock bay 76 and with the railcar 26 being at a distance from the rail coupler knuckle 142. The optional coupler shank 143 is also illustrated.

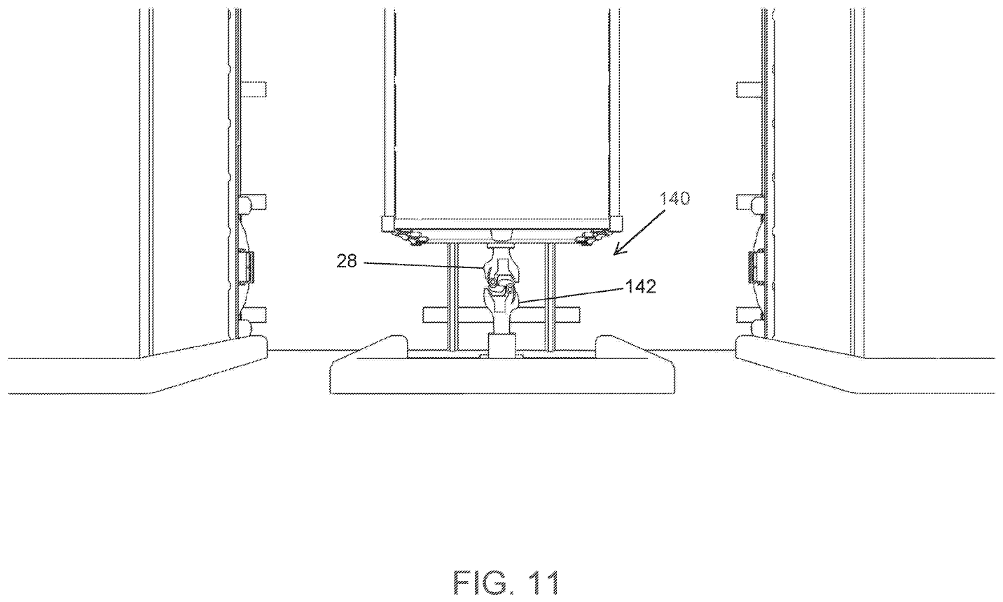

FIG. 11 illustrates a partial planar view of the railcar restraint of FIG. 10 with the railcar coupler and railcar restraint 140 being coupled to each other and respective coupler knuckles 28 and 142.

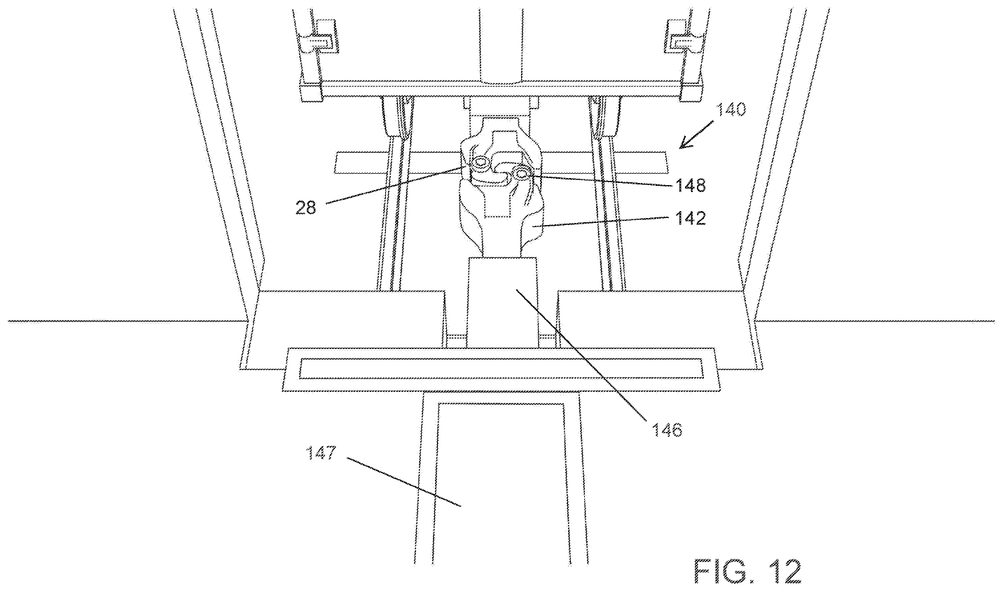

FIG. 12 illustrates a partial perspective view of the railcar restraint of FIG. 11 looking from inside (hollow interior) of the terminal building 70. An optional draft gear 146 is illustrated. Also illustrated is a floor cover 147 that is provided to at least partially contain the railcar restraint 140.

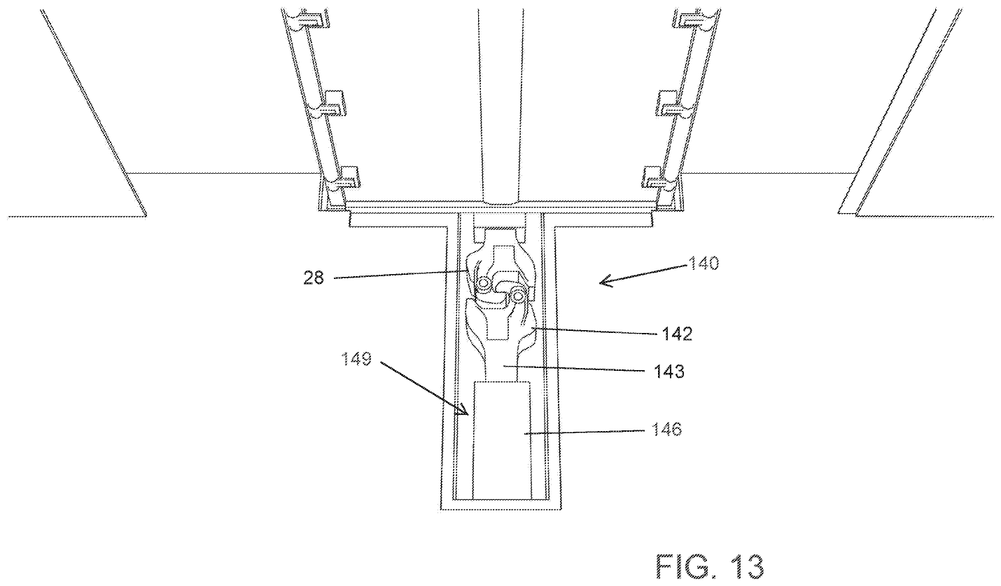

FIG. 13 illustrates a perspective view of the railcar restraint 140 with the draft gear 146 being in a fully retracted position in a cavity 149 within a floor of the terminal building 70. Floor cover 147 of FIG. 12 has been removed in FIG. 13.

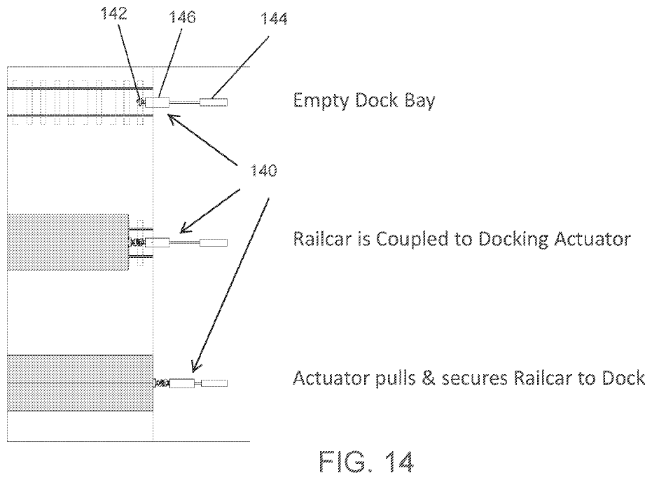

FIG. 14 illustrates a block diagram of a railcar restraint operation. When the dock bay 76 is empty, the restraint (docking) actuator 144 may be extended to position the coupler knuckle 142 external to the wall of the terminal building 70. Then the railcar is coupled to the railcar restraint 140. Next, the restraint (docking) actuator 144 is energized to pull the railcar toward the dock bay 76 and temporarily secure such railcar during loading/unloading process. The restraint (docking) actuator 144 may be of a linear type design.

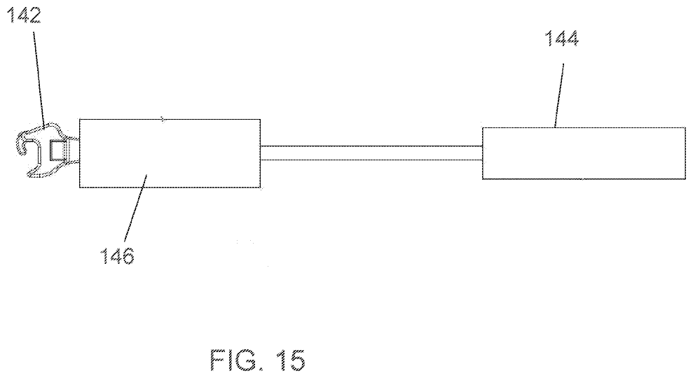

FIG. 15 illustrates a block diagram of the railcar restraint 140. An optional draft gear 146 is illustrated as being mounted between the restraint (docking) actuator 144 and the restraint rail coupler knuckle 142.

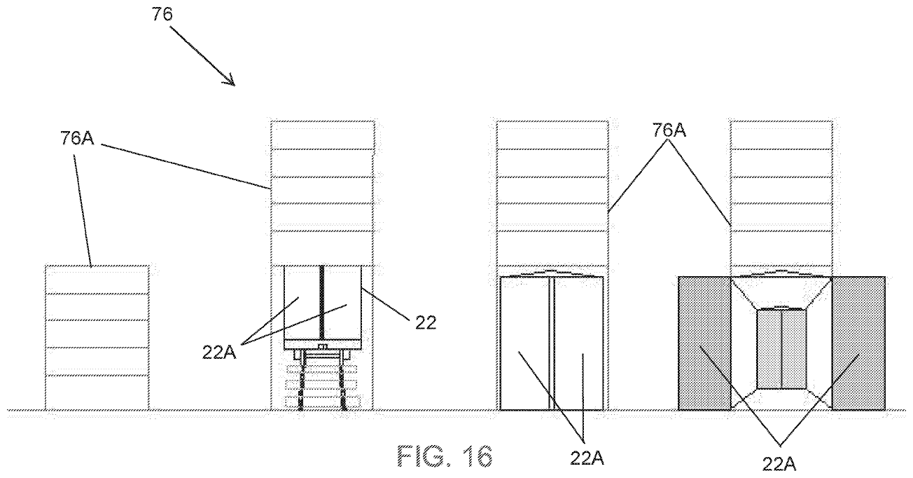

FIG. 16 illustrates an elevation view of the railcar dock bays 76 with end doors 22A of the rail cars 22 being in closed and open positions. The door 76A of the dock bay 76 is illustrated as an overhead door.

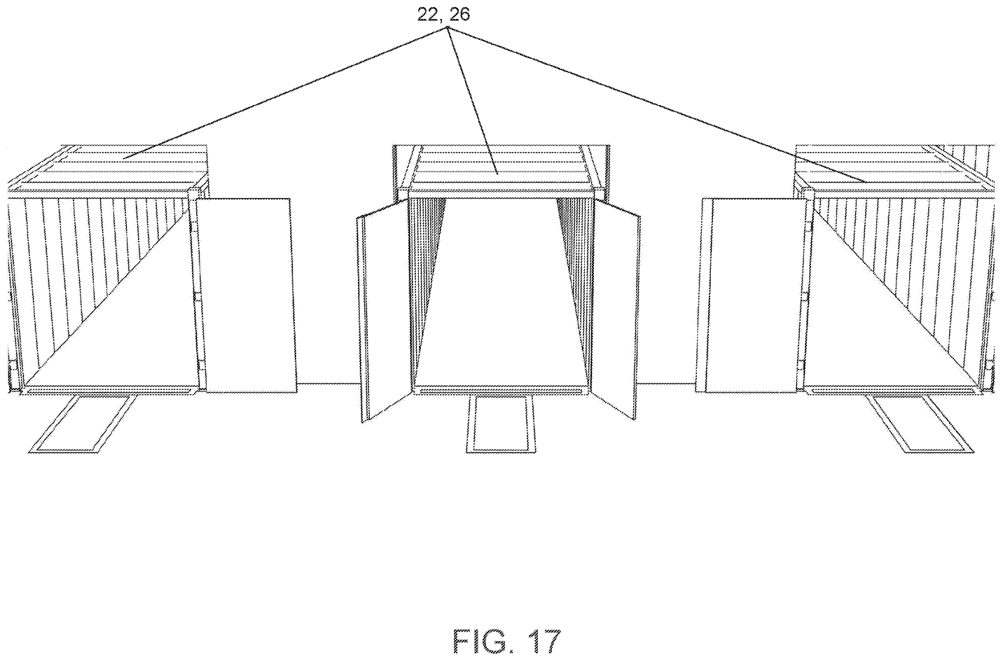

FIG. 17 illustrates a partial perspective view of the railcar dock bays with dock bay doors and railcar end doors being open.

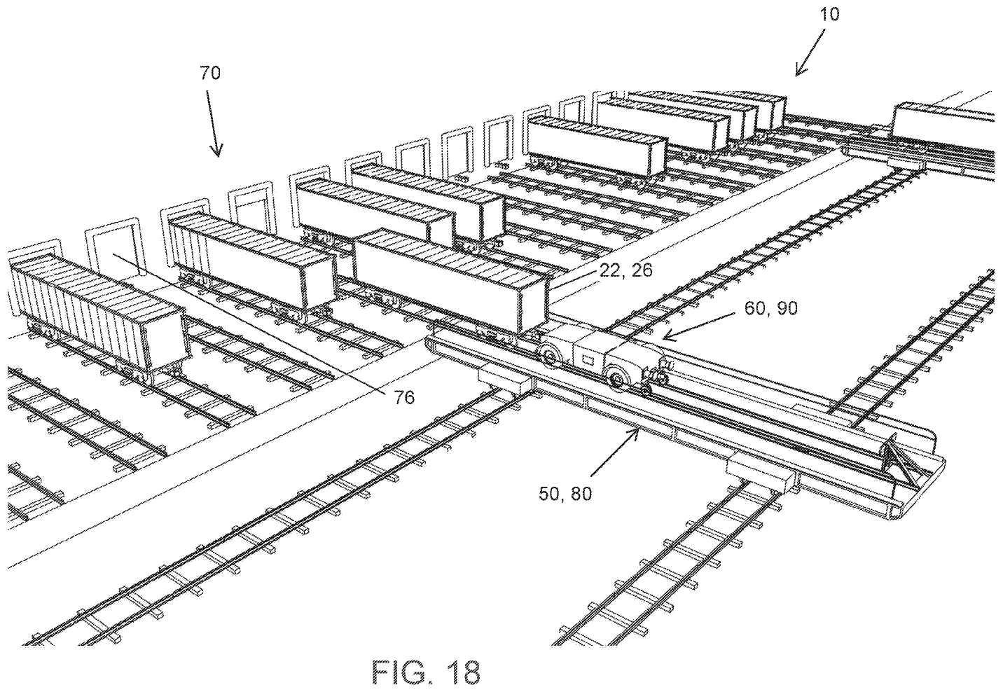

FIG. 18 illustrates a partial enlarged perspective view of the terminal 10, particularly showing handling of the railcar 22, 26 at a terminal building 70 with the railcar mover 60, 90 and the railcar transfer bridge 50, 80.

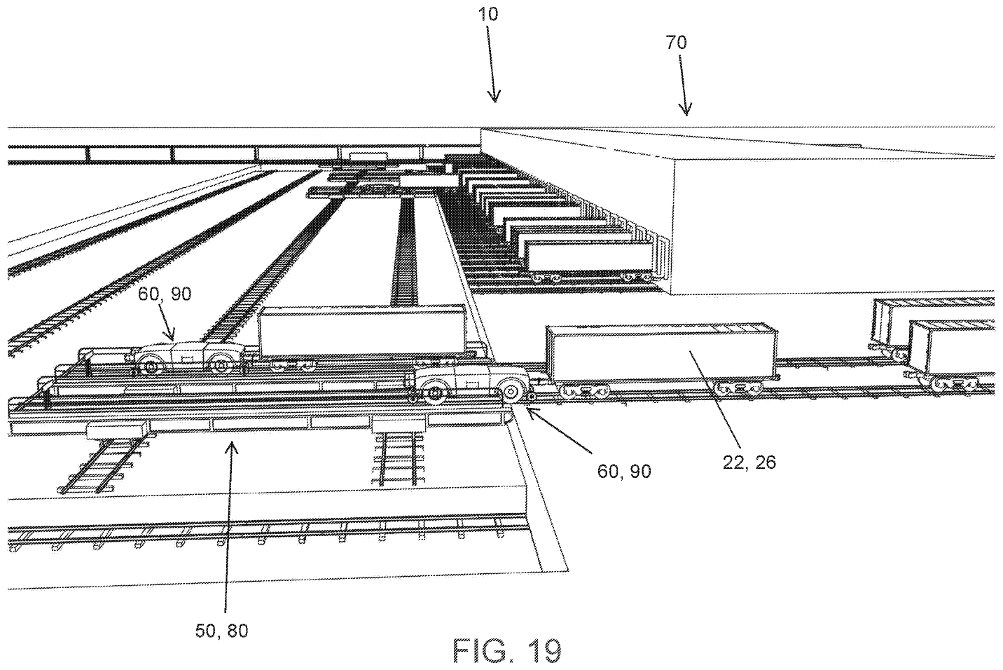

FIG. 19 illustrates a partial perspective view of the terminal 10, particularly showing handling of the railcar 22, 26 at the railcar staging area with a pair of self-propelled railcar transfer bridges 50, 80, each with the railcar mover 60, 90. The railcar staging area may handle inbound and/or outbound traffic.

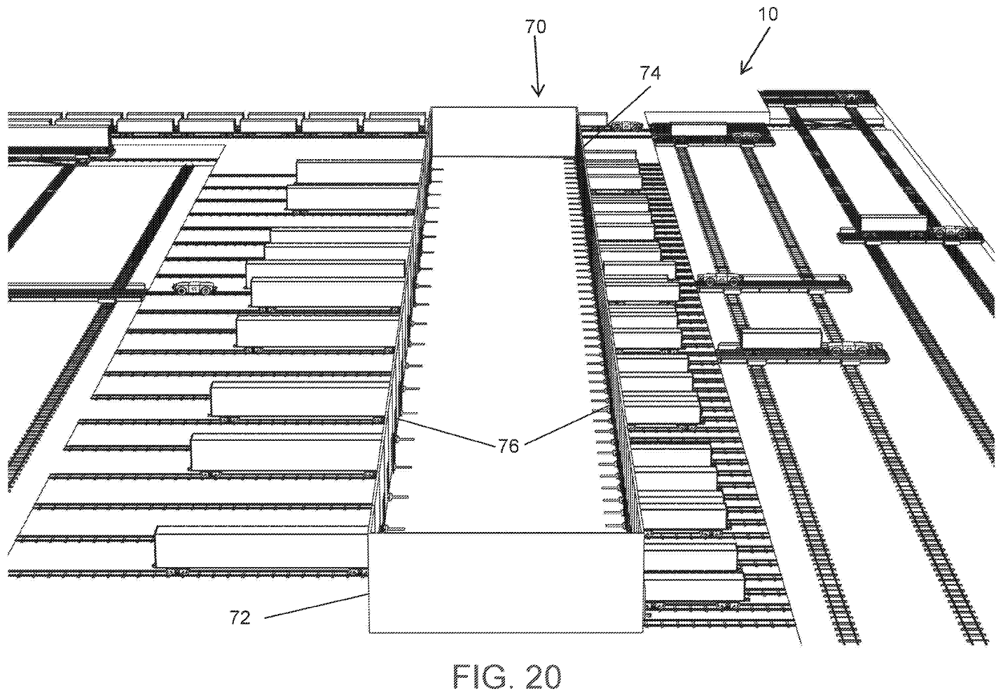

FIG. 20 illustrates a partial perspective view of the railcars at a terminal building 70 designed to handle railcars of different sizes with two railcar transfer apparatuses.

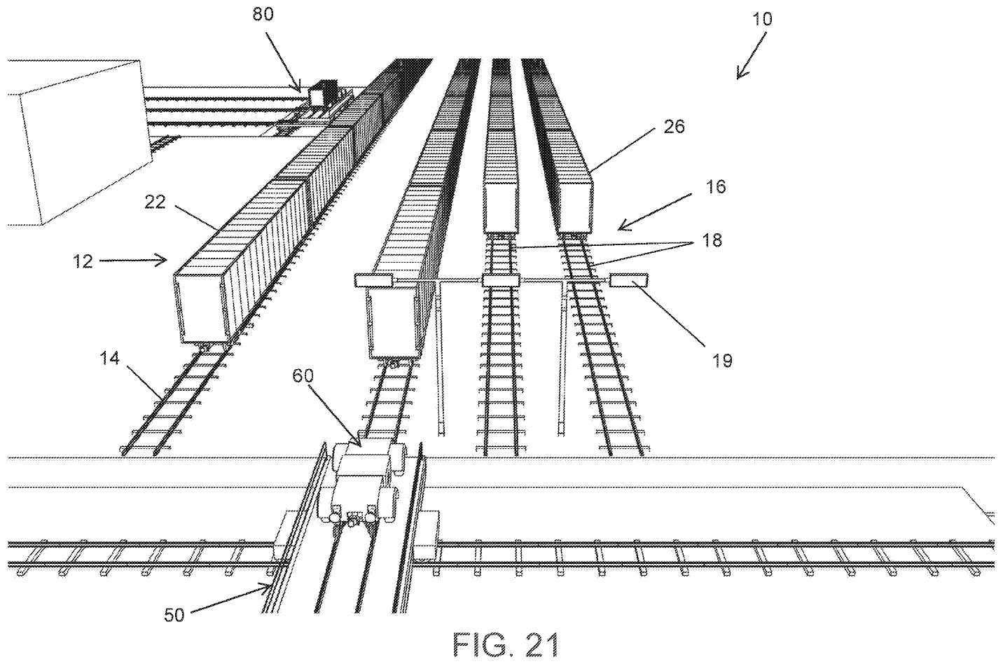

FIG. 21 illustrates a partial perspective view of the terminal 10, particularly illustrating two different railcar staging areas 12 and 16. Staging area 12 is illustrated with a single rail track 14 while staging area 16 is illustrated with multiple rail tracks 18. Staging area 12 may be used to handle inbound traffic while staging area 16 may be used to handle outbound traffic. Train consist destination signs 19 may be used to indicate a specific destination of a train consist on a specific rail track 18. The railcar transfer bridges 50 and/or the railcar mover 60 may be adapted with a sensor designed to read information on the destination sign 19 and couple the railcar 26 based on the programmed set of instructions and/or as commanded by the dispatch (control) center within the terminal 10.

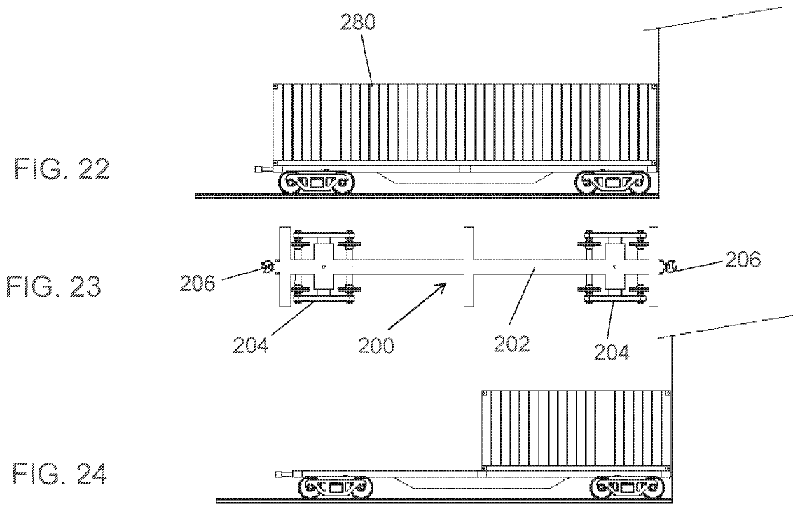

FIGS. 22-24 illustrate an elevation view of a rail chassis 200 supporting a freight container 280 and FIG. 23 illustrates a plan view of the rail chassis 200. The rail chassis 200 may be designed with a frame 202 that is supported by two railway bogeys 204. A rail coupler 206 is mounted at each end of the frame 202. The rail chassis 200 may be designed with an optional draft gear at each rail coupler 206, an optional brake rigging and an optional hand brake. Such rail chassis 200 may be employed in moving marine containers from a marine terminal 10 building to a freight consolidation facility. At such freight consolidation facility, the freight may be transferred between marine containers and end loading/unloading box cars. Or, marine containers may be removed from the rail chassis 200 and placed on railcars designed to transfer such marine container for a longer distance. The rail chassis 200 may be referred to as a spine railcar.

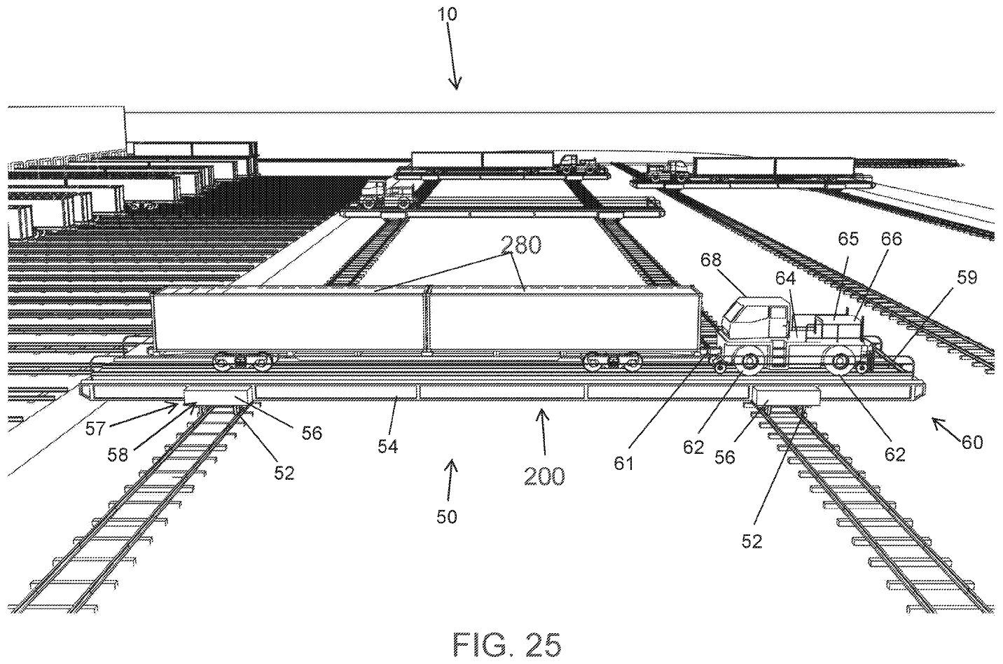

FIG. 25 illustrates a partial perspective view of the terminal 10 with a pair of freight containers 280 mounted, in a tandem configuration, on a single rail chassis 200 carried on the railcar transfer bridge 50. Each freight container may be a marine type freight container with a door at one end. When the terminal 10 is designed to handle such marine containers positioned in tandem on a single rail chassis 200, each container will have its end door positioned at a respective end of the chassis 200.

FIG. 25 also illustrates drive motor 56 with a power source 57 and a controller 58 of the railcar transfer bridge 50. FIG. 25 also illustrates the railcar mover 60 with wheel sets 62, a frame 64, a drive motor 65, a power source 66 and an operator cab 68.

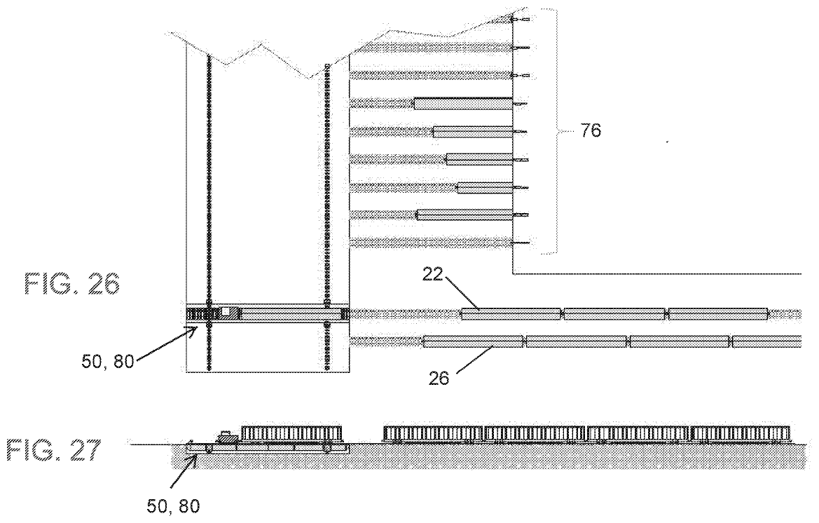

FIGS. 26-27 illustrate a layout of a terminal 10 with a single staging area and a single railcar transfer bridge 50, 80 for inbound and outbound railcars.

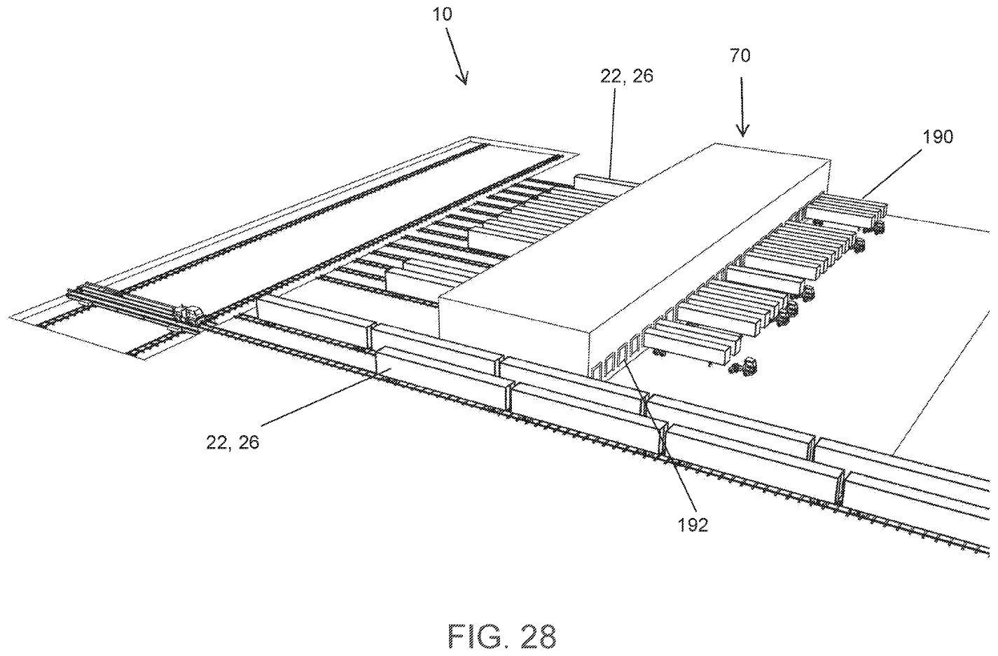

FIG. 28 illustrates a perspective view of the terminal 10 of FIGS. 26-27 particularly illustrating railcars 22, 26 on one side of the terminal building 70 and tractor trailers 190 on the opposite side of the terminal building 70.

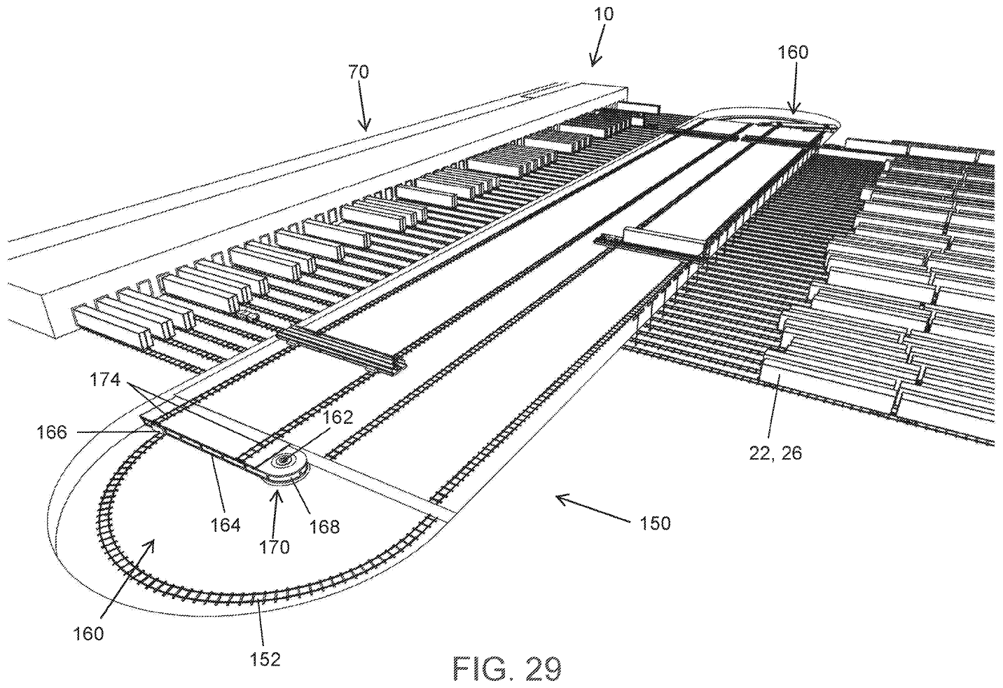

FIG. 29 illustrates a perspective view of a terminal 10 with an oval-shaped railcar transfer apparatus 150 and with a railcar transfer assembly 160 that is designed with a platform 164 that rotates or pivots, with the drive motor 168 and a power source 170 about a post 162 to move the railcar transfer bridge 50, 80 from one pair of rail track segments to another pair of rail track segments. The other end of the platform 164 is supported on the wheeled bogey 166 that travels on the curved rail track segment 152. The design in FIG. 29 may be referred to as a transloading facility where railcars 22, 26 are positioned on multiple rail tracks within the staging area. Some rail tracks handle inbound freight traffic while other rail tracks handle outbound freight traffic. Truck trailers (not shown) are docked at an opposite side of the building. The oval-shaped railcar transfer apparatus 150 may be provided by adding curved rail track portions to the above described railcar transfer apparatus 30 and/or 40.

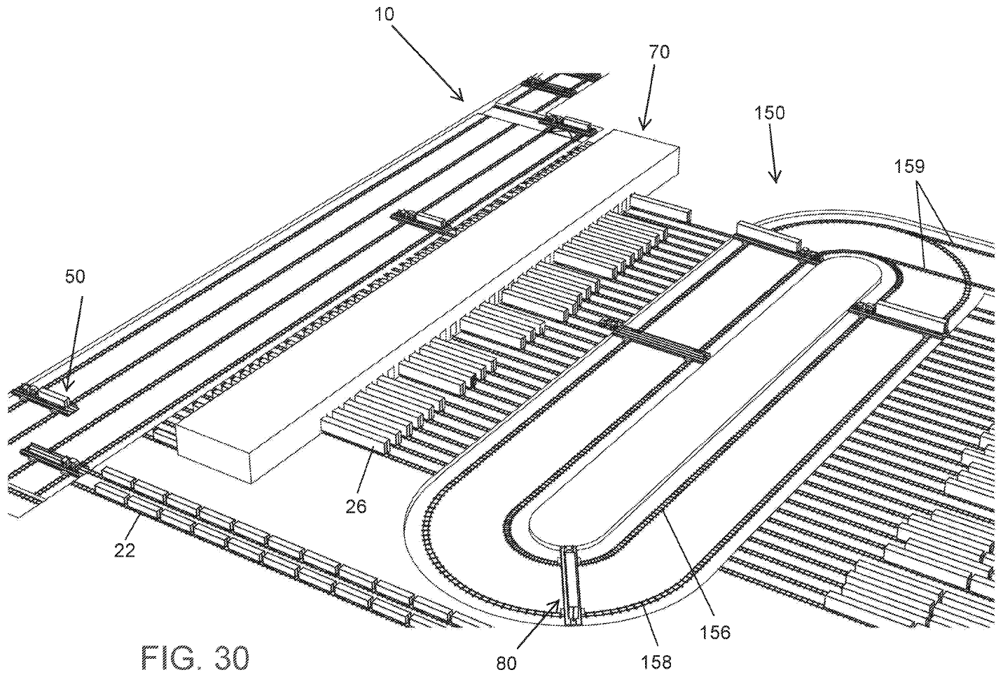

FIG. 30 illustrates a perspective view of a terminal 10 with an oval-shaped railcar transfer apparatus 150 including an oval-shaped rail track configuration with a pair of oval-shaped rail tracks 156 and 158. Such A railcar transfer bridge staging track segments 159 are also illustrated as being connected to the oval-shaped rail tracks 156 and 158. Such terminal 10 may be designed to transload freight between railcars in an absence of the terminal building 70.

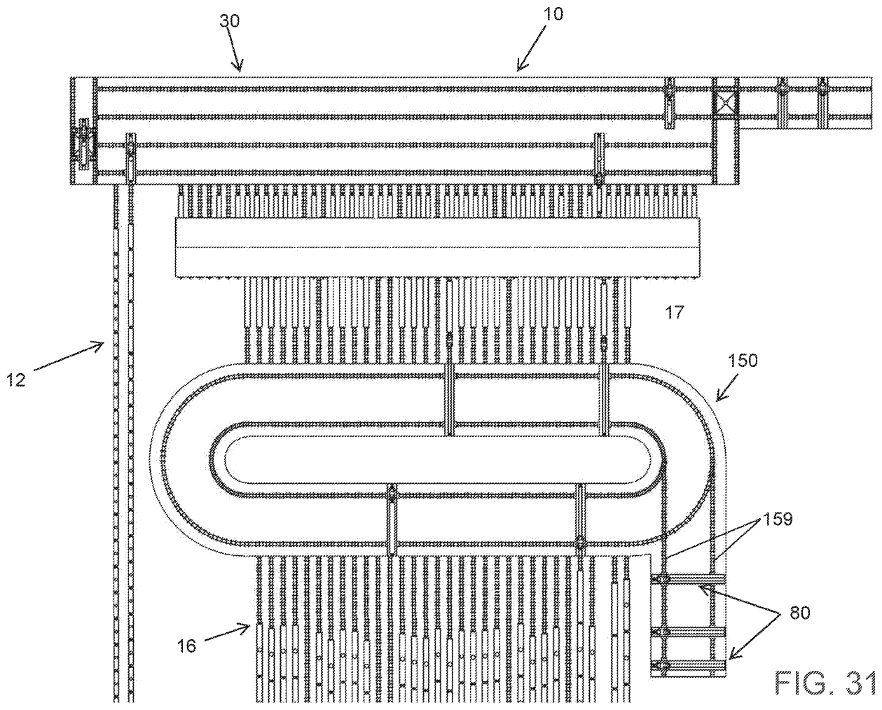

FIG. 31 illustrates a plan view of the terminal 10 of FIG. 30.

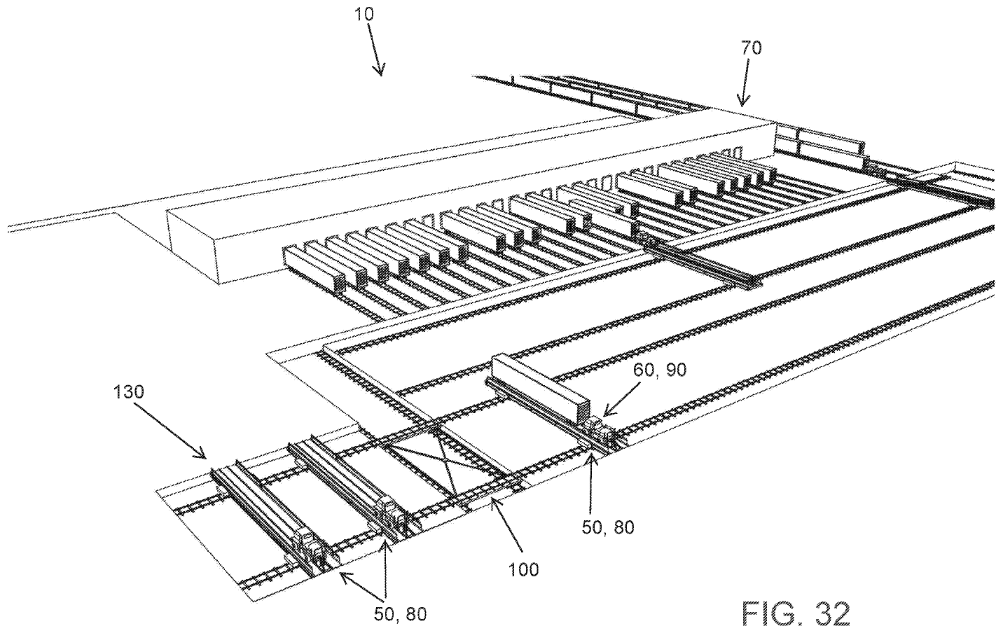

FIG. 32 illustrates a partial perspective view of the terminal 10, utilizing a single staging area for both inbound and outbound freight traffic. A staging area 130 for spare railcar transfer bridges 50, 80 may be also utilized in this design.

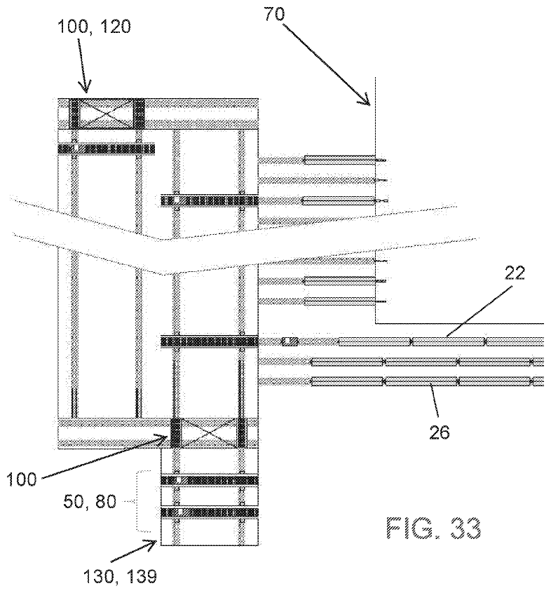

FIG. 33 illustrates a partial plan view of the terminal 10.

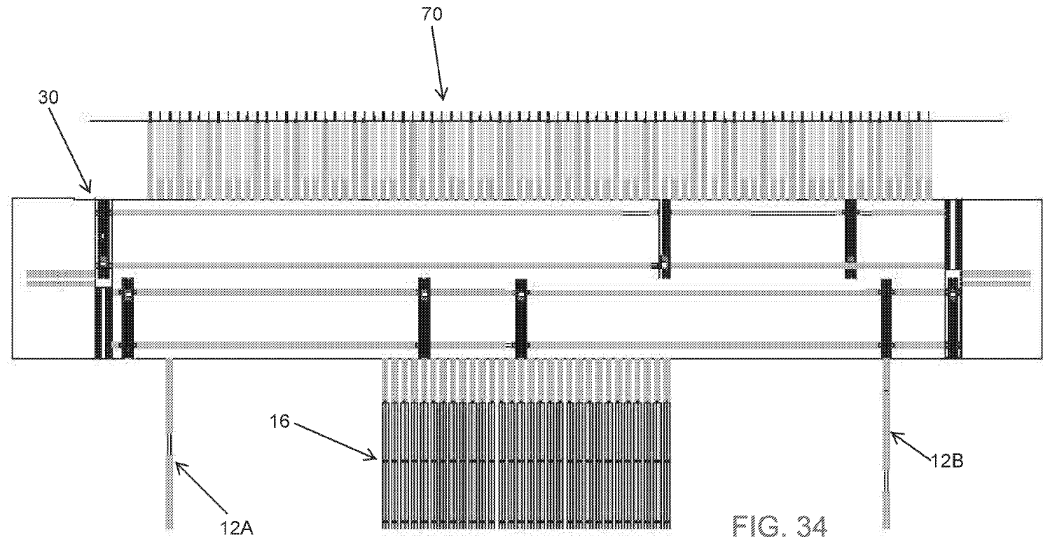

FIG. 34 illustrates a partial plan view of the terminal 10 where the outbound staging area 16 is disposed between two inbound staging areas 12A and 12B. However, the staging areas may be reversed where a single inbound staging area is disposed between two outbound staging areas.

FIG. 35 illustrates a plan view of the terminal 10 including an oval-shaped railcar transfer apparatus 150.

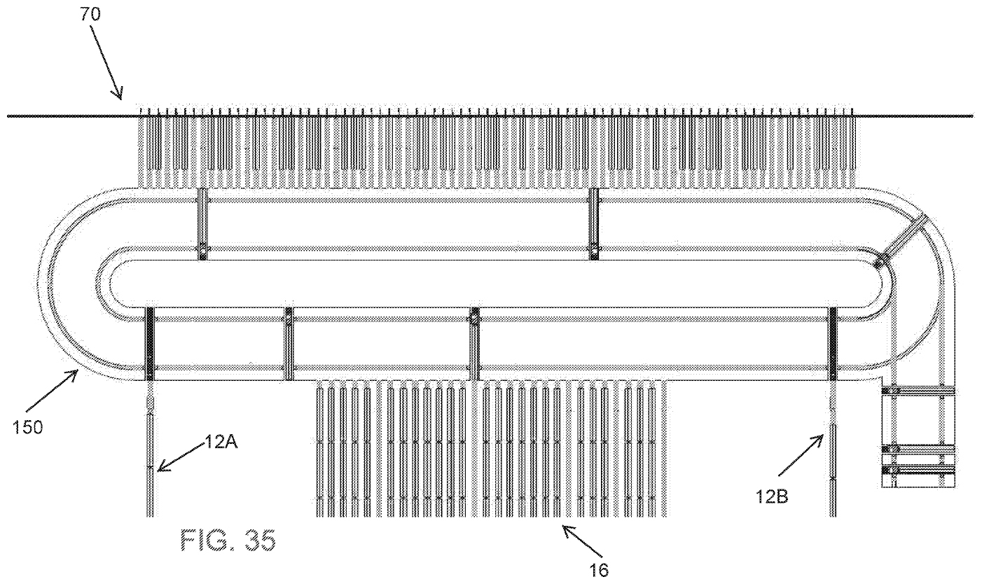

FIG. 36 illustrates a perspective view of the terminal 10 with railcar staging areas 12 and 16 and with oval-shaped railcar transfer apparatus 150 including railcar transfer assemblies 160.

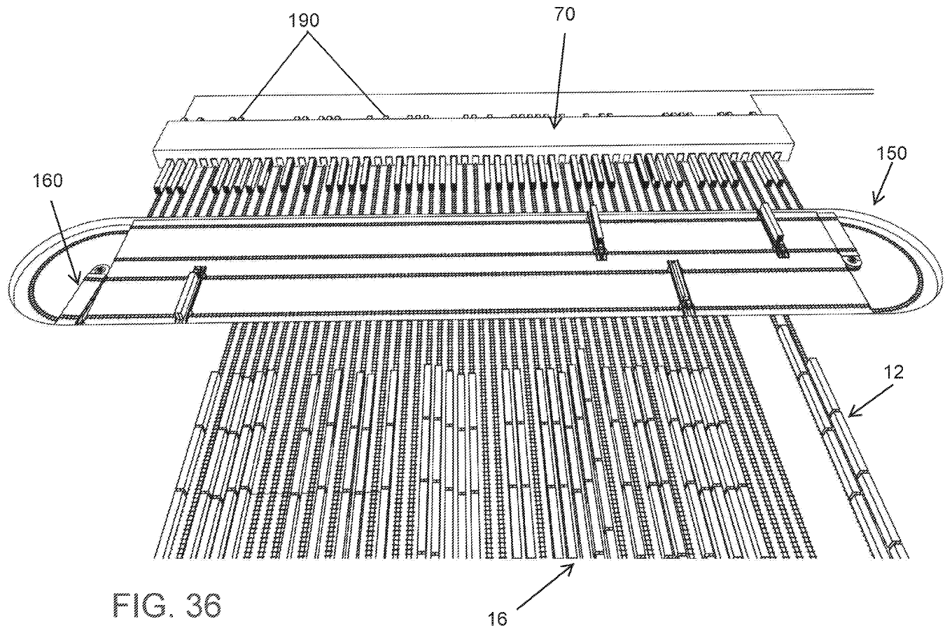

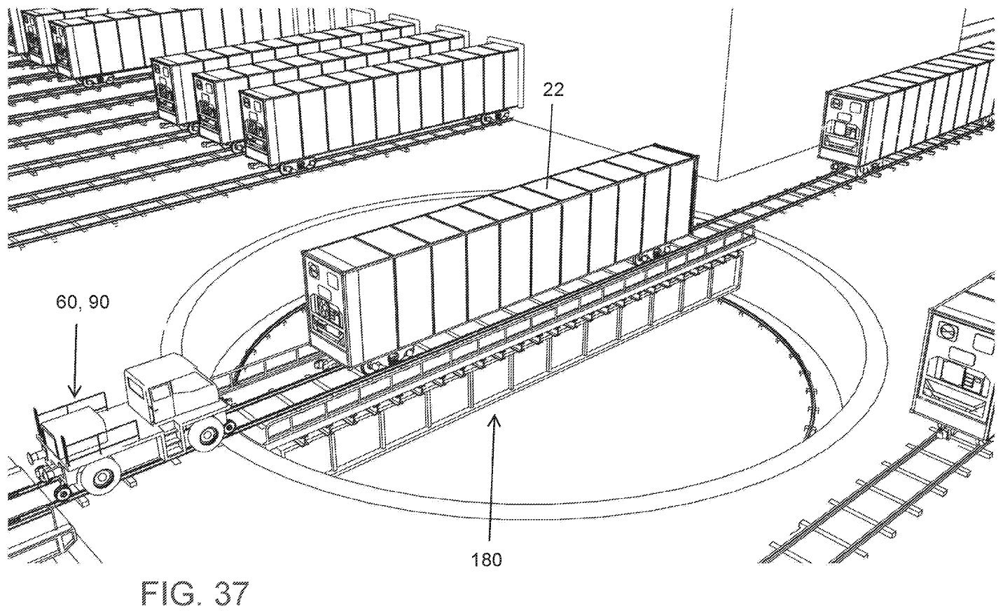

FIG. 37 illustrates a partial perspective view of the terminal 10 with a transfer carousel 180 designed to rotate railcars, particularly refrigerated railcars so as to positioned a non-AC end at the dock bay door.

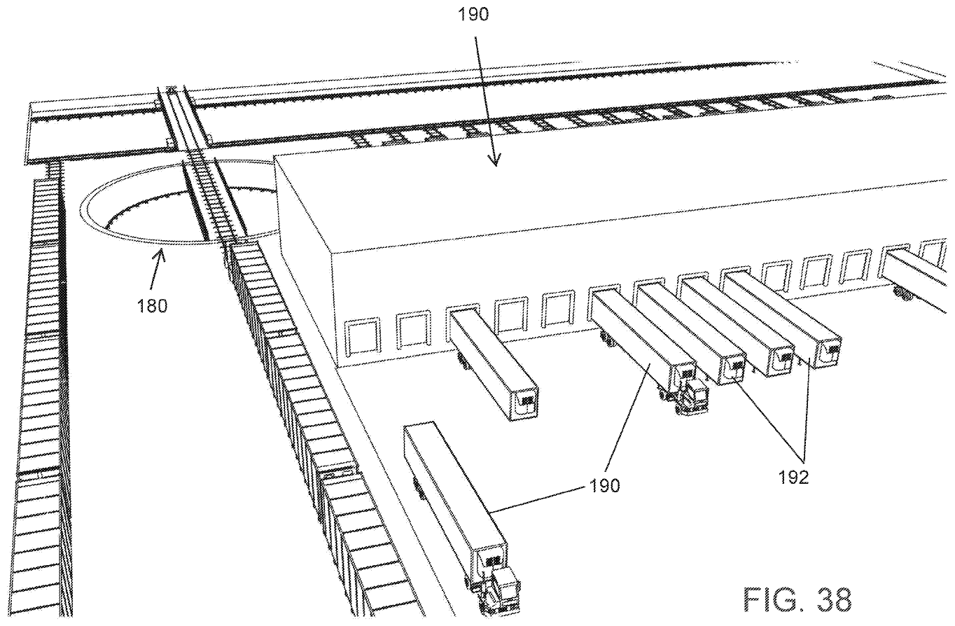

FIG. 38 illustrates a partial perspective view of the terminal 10 designed to handle railcars and tractor trailers 190 of a refrigerated type.

FIG. 39 illustrates a partial perspective view of the terminal 10 designed to handle railcars and tractor trailers 190 in tandem at one wall of the terminal building 70. The railcar transfer apparatus 30 may be provided with a single pair of tracks.

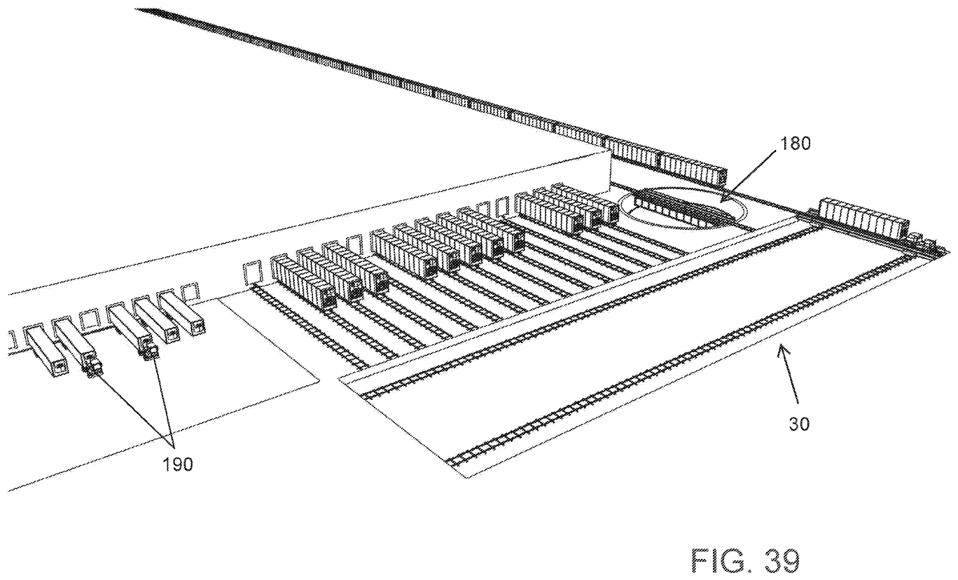

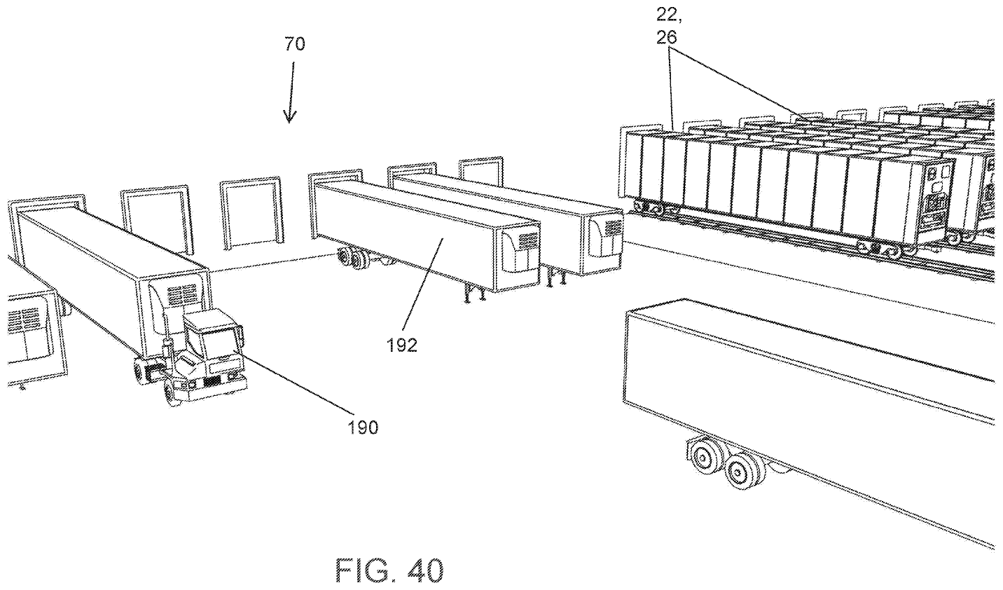

FIG. 40 illustrates an enlarged partial perspective view of the terminal 10 of FIG. 39 designed to handle railcars and tractor trailers 190 of a refrigerated type.

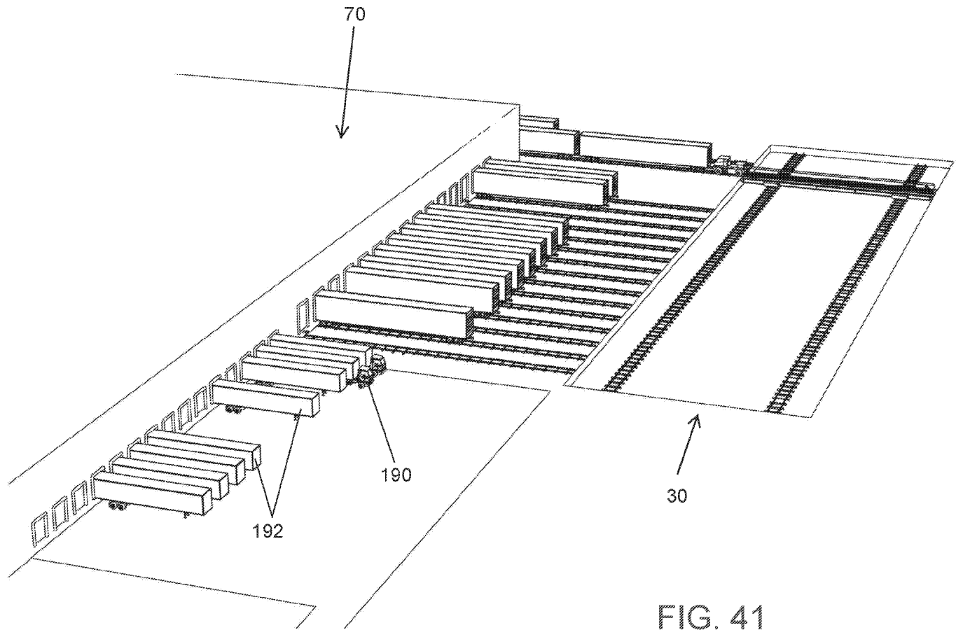

FIG. 41 illustrates a partial perspective view of the terminal 10 designed to handle railcars and tractor trailers 190 in tandem at one wall of the terminal building 70.

FIG. 42 illustrates a perspective view of the terminal 10 with a transfer carousel 180.

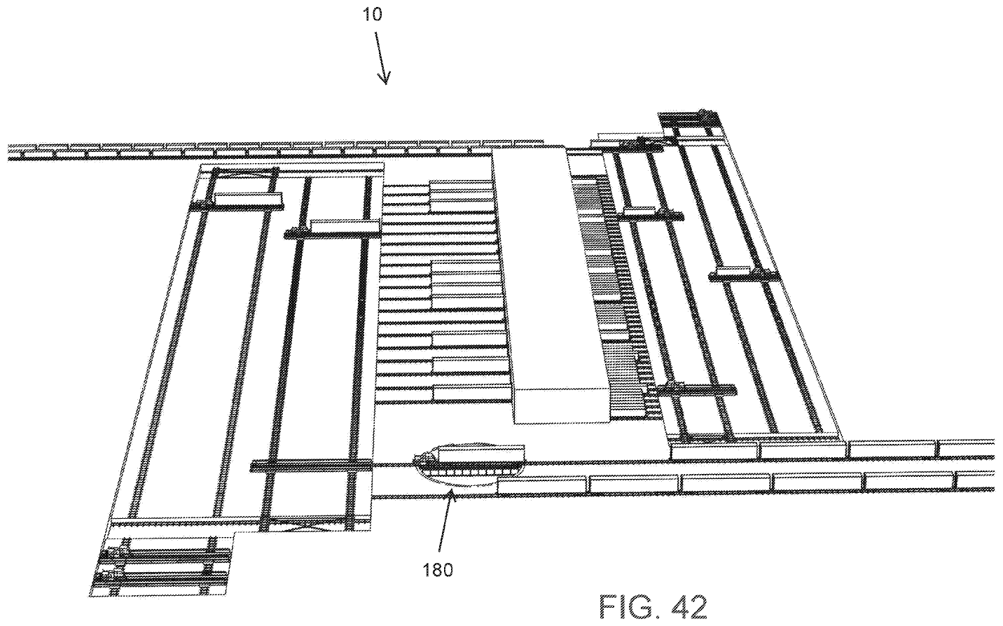

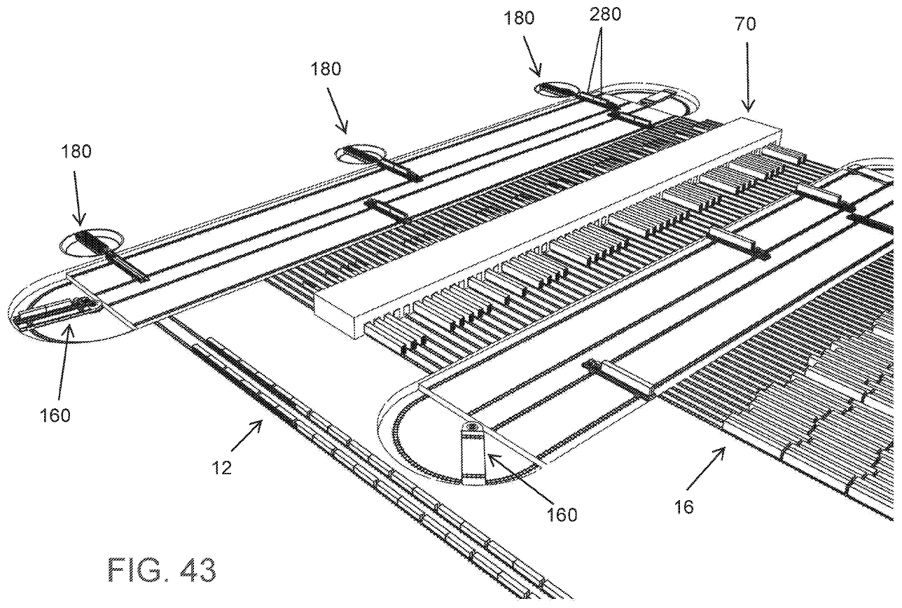

FIG. 43 illustrates a perspective view of the terminal 10 with a double oval-shaped transfer area. The transfer carousel 180 is being illustrated as disposed in a series along one oval-shaped transfer area. This design may be used in applications that require a specific orientation of even non-refrigerated railcars prior to docking such railcars at dock bays or changing orientation of the railcars. In a non-limiting example, the transfer carousel 180 may be used to rotate the railcar with two marine containers 280 so as to position an end of each container 280 at the dock bay.

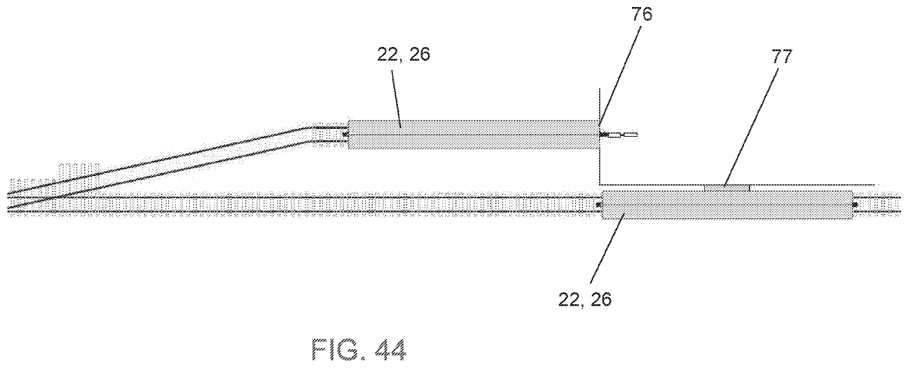

FIG. 44 illustrates a diagrammatic plan view of an end-loading/unloading railcar arrangement that utilizes a rail track branch to dock bay 76 without use of railcar transfer bridges. A side dock bay 77 is also illustrated to be used with box-type railcars with a side door.

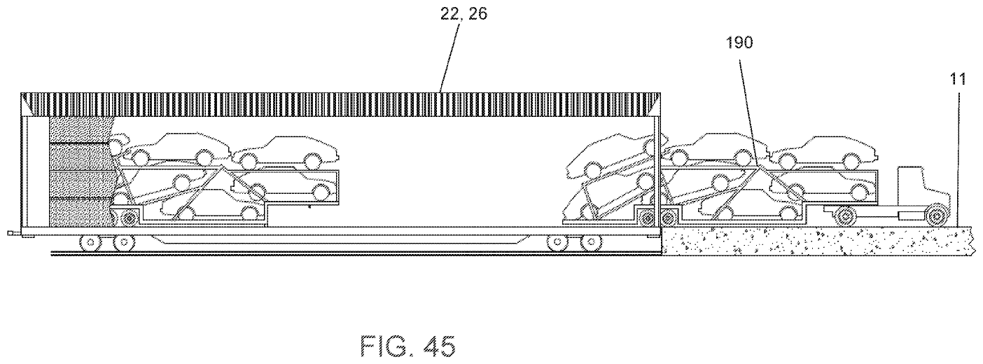

FIG. 45 illustrates an elevation view of an intermodal auto delivery design in an absence of a terminal building 70 with the freight being loaded and off-loaded at a ground level 11. The railcar 22, 26 is illustrated in FIG. 45 as an auto rack type.

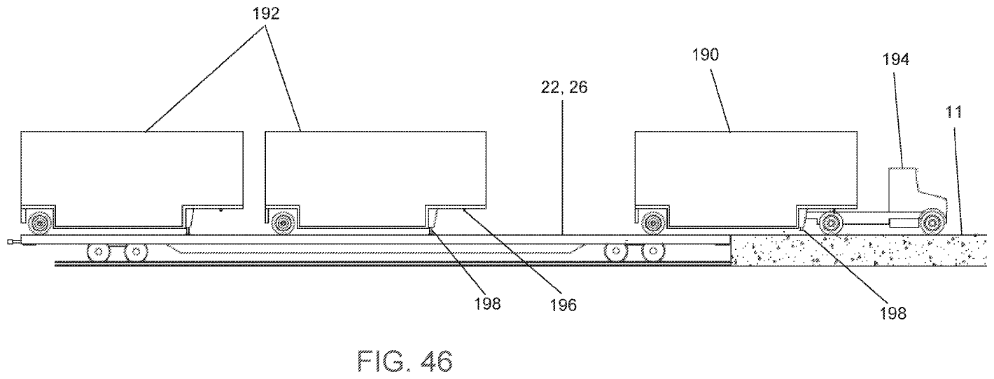

FIG. 46 illustrates an elevation view of an intermodal freight delivery design in an absence of a terminal building 70. Trailers 192 are disposed on the railcars 22, 26 of a flatbed-type. The trailers are individually loaded or unloaded with a tractor 194 through a kingpin 196. An air-operated stanchion 198 may be used to anchor the trailer 192 to the platform of the railcar 22, 26. The air-operated stanchion 198 is raised when the trailer 192 is coupled to the tractor 194. Trailer 192 may be referred to as a pup trailer.

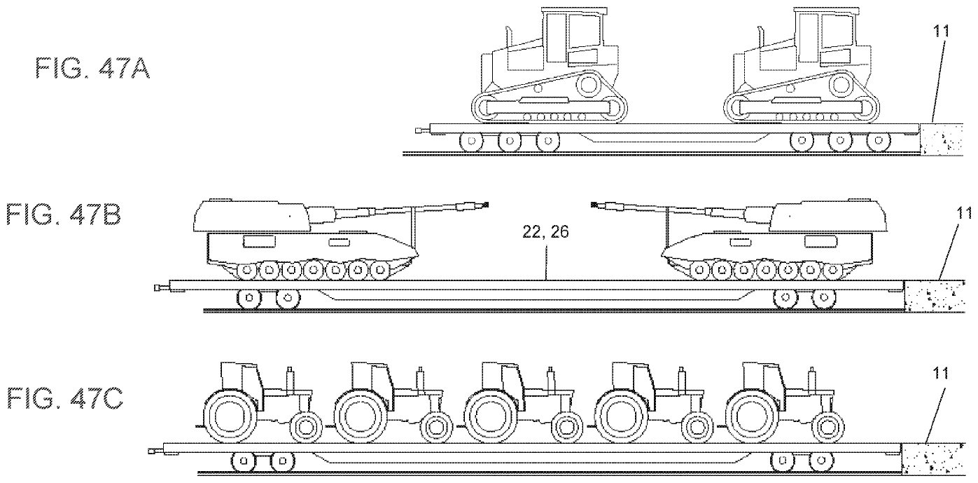

FIGS. 47A-47C illustrate elevation views of intermodal freight delivery designs in an absence of a terminal building 70. This design may be used for powered roll-on, roll-off type vehicles.

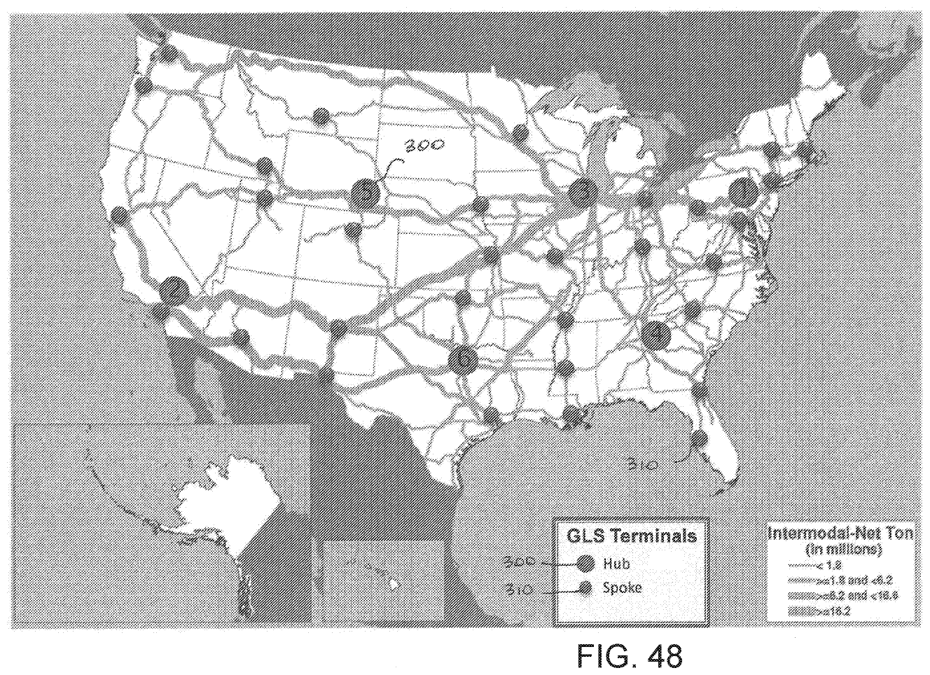

FIG. 48 illustrates a diagrammatic view of an intermodal network utilizing a network of hub terminals 300 and spoke terminal 310. The hub terminal 300 may handle a greater amount of railcars than the spoke terminal 310.

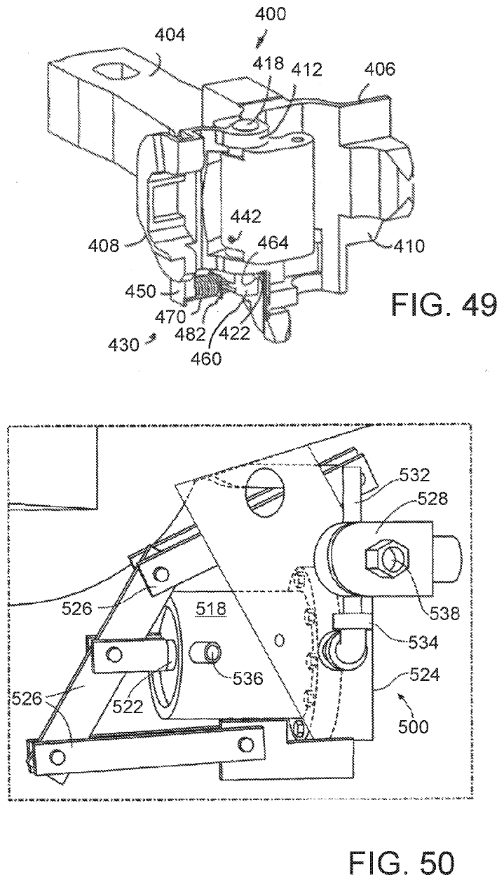

FIG. 49 illustrates a perspective view of a railcar coupler 400 with an automatic cut lever apparatus 430 for automatically pivoting and maintaining a full open position of a coupler knuckle 424. The coupler knuckle 424 is mounted for independent rotation on the knuckle pin 416 by way of a longitudinal aperture and is caged between the pair of bifurcated members 412. The railcar coupler 400 includes a coupler shank portion 404 and a coupler head 406 which has a knuckle side 408 and a guard arm side 410. The coupler head 406 further includes a pair of bifurcated members 412 each having an aperture for receiving a generally cylindrical knuckle pin 418. The knuckle pin 418 may have a mushroomed head engageable with an upper bifurcated member 412 and an aperture formed in the bottom end of the knuckle pin 418 for receiving a cotter pin 422.

A support 50 is attached to the knuckle side 408. The support 50 may be rigidly fixed to the knuckle side 408 of the coupler head 406 and extends generally downwardly from the coupler head 4066. The support member 450 may be fixed to the knuckle side 408 by a welding method. A pivot 460 is rigidly attached to the knuckle pin 416 for a simultaneous rotation therewith. A compression member 470 may be also provided. The compression member 470 may be a coiled spring. The spring 470 may be caged between the support member 450 and the end 82 of a movable support.

In operation, when the coupling mechanisms (not shown) are coupled, the coupler knuckle 424 closes, thus compressing the compression spring 470, which in turn stores the energy. When a lock (not shown) is employed with the rail coupler 402 is lifted for uncoupling operation and the couplers move apart, the stored energy in the spring 470 opens the knuckle 24 to its full open position and maintains it in such position, making it ready for next coupling operation.

FIG. 50 illustrates a perspective view of a railcar coupler with an automatic cut lever apparatus 500.

This automatic cut lever apparatus 500 includes a cylinder 518 which has a piston 522 disposed therein. The automatic cut lever apparatus 500 also includes a bracket 524 that attaches to the railcar coupler (not shown) to support the cylinder 518.

A linkage 526 may be connected to each of the piston 522 of a cylinder 518 and the lock lift assembly for converting a lateral motion of piston 522 to a curvilinear motion of such lock lift assembly to either lock or unlock the coupler knuckle. A valve 528 may be connected to the cylinder 518 for either communicating pressurized fluid to the cylinder member when a predetermined signal is sent to the valve 528 or preventing pressurized fluid from entering the cylinder 518 in an absence of the predetermined signal.

The automatic cut lever apparatus 500 may include a first pipe 532 having a first end connected to a predetermined source of pressurized fluid, which is preferably a train line (not shown) of the rail car (not shown) and a second end connected to the inlet side of valve 528 for communicating the pressurized fluid to such valve 528.

The automatic cut lever apparatus 500 may further include a second pipe 534 having a first end connected to the outlet side of valve 528 and a second end connected to the cylinder 518 for communicating pressurized fluid from the valve 528 to the cylinder 518 when the signal is sent.

As air enters the pneumatic cylinder 518 on a front side of the piston 522, air behind the piston 522 is evacuated through a first vent member 536. The linkage 526 converts the lateral motion of the piston 522 to the curvilinear motion of the lock lift assembly.

In the absence of an electrical signal, the three-way solenoid valve 528 is closed thus preventing pressurized air from entering the pneumatic cylinder 518. Also, the pneumatic cylinder 518 can vent to atmosphere in the closed position of the valve 528 back through second pipe 534 and out a second vent 538. This allows the lock to drop and the pneumatic piston 522 to retract via the weight of the linkage 526 to the closed (default) position.

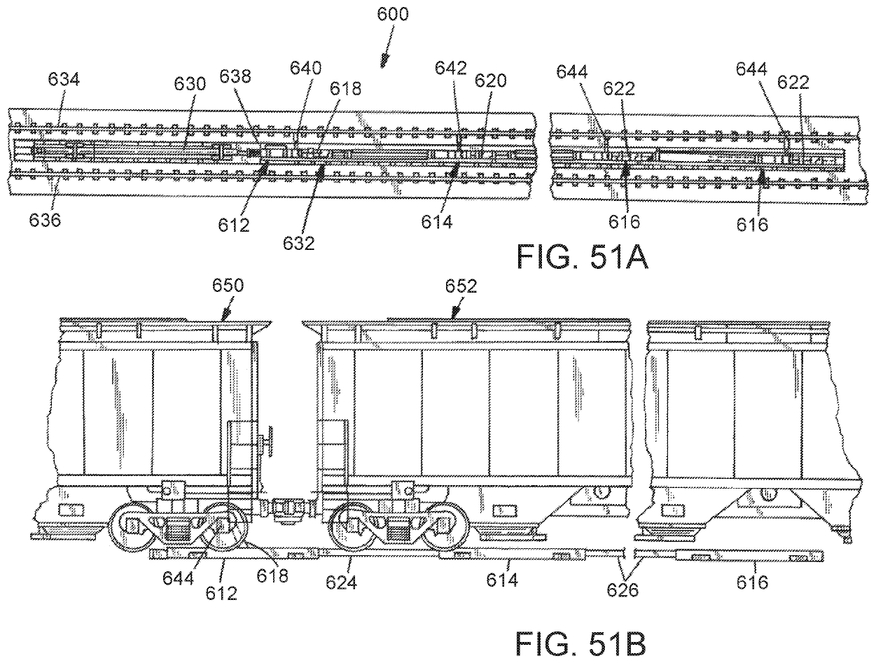

FIG. 51A illustrates a general schematic plan or layout view of a railcar indexer 600. The railcar indexer 600 is illustrated as an axle-engaging railcar indexer.

The railcar indexer system shown generally at 610, includes three identical dog carriage units, including a lead or front carriage unit 612, a middle or second dog carriage unit 614 and a rear or third dog carriage unit 616. The dog carriage units each carry a single, heavy, axle-engaging dog member. The dog members are designated 618, 620 and 622, respectively. The dog carriages are fixed together in tandem and spaced by connecting members 624 and 626. The carriages are operated by a connected hydraulic system that includes a main operating cylinder 630 connected to the front carriage 612. A cylinder for use in the design of the illustrated embodiment may be a double-acting hydraulic cylinder having a 6½ inch bore, a 4 inch diameter rod and a 19 foot stroke. It will be appreciated that the stroke length of the cylinder and length of connecting members 624 and 626, which determine carriage separation, will vary with the length of the railcars to be processed by the system. Hydraulic fluid is supplied to the dog carriages along with the cylinder to operate the dogs in a well-known manner. Thus, the dogs are manually spring-biased in a down position and hydraulic fluid pressure is used to overcome the spring force to raise the dogs as required.

As shown, the indexer system of the present invention is operated along a guideway 632 which is mounted between rails 634 and 636. A full retract proximity switch, which indicates the end of a full pull stroke, is shown at 638. A front carriage wheel sensor is shown at 40, a middle carriage wheel sensor is shown at 642 and a rear carriage wheel sensor is shown at 644.

FIG. 51B illustrates partial side elevational views of railcars 650 and 652 with dog 618 of front carriage 612 raised and addressing the last axle 654 of railcar 650.

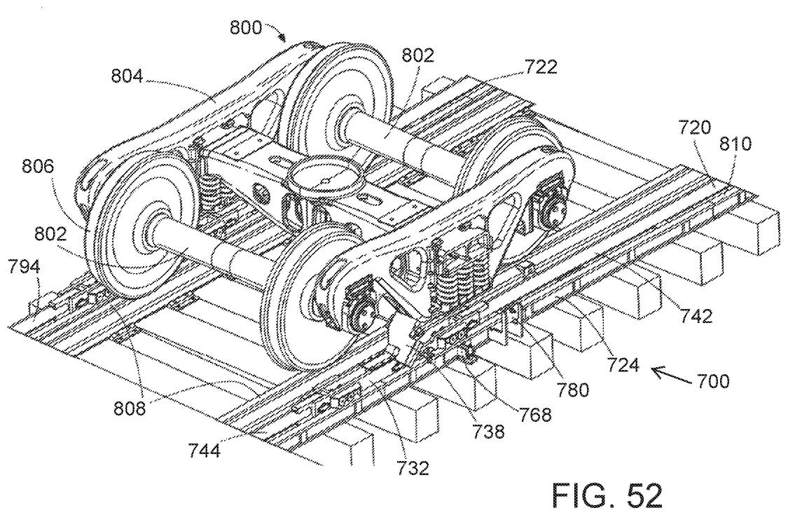

FIG. 52 illustrates a partial view of a railcar indexer 700 with a low dog addressing a bogey frame of a railcar truck. A railcar bogey 800 includes a pair of spaced axels 802 journaled in a bogey frame 804. Flanged wheels 806 ride on spaced rails 808 that are part of rail tracks 14 and 18 in view of the above figures. A raised low dog 738 is shown addressing bogey frame 804 from dog carriage 732 as it rides on carriage indexer track 810.

A positioner 720 includes an elongated guideway or indexer track at 724 (shown in broken segments for clarity and convenience) which houses the components of a railcar-moving indexer system designed to operate reciprocally along the guideway 724. The components of the railcar-moving arrangement include a hydraulic cylinder with associated rod. Three spaced dog carriages are provided including a cylinder dog carriage, a mid dog carriage 732 and an end dog carriage (not shown), which carry vertically pivoting low dog pushing devices shown at 738. The dog carriages are connected at fixed spacings by mechanical linkages and connecting rods as at 742 and 744. The dog carriage is connected to the cylinder rod.

The dogs are spring-biased to a raised or pushing position and must be forced or pushed down to be lowered. Devices are provided to automatically lower and retain the corresponding dogs in a lowered or dropped position under certain circumstances. These include a latch on each dog carriage associated with a latch wheel and a cam operated mechanical arrangement which ramps an associate dog down. An associated dog latch tripper flag is provided to unlatch the dog, as will be described.

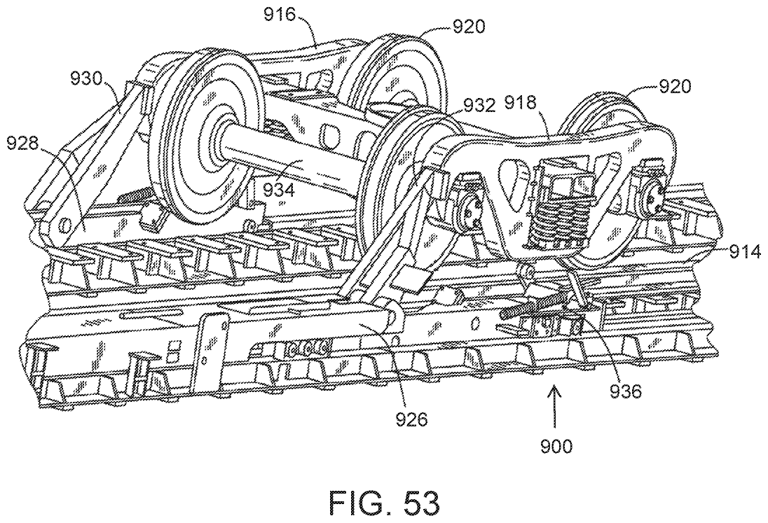

FIG. 53 illustrates a partial plan view of a railcar indexer 900 with a high dog and a bogey frame sensing shown with a single railcar wheel truck assembly. The bogey is configured to be situated on a rail track having rails 914. The bogey includes spaced frame sides 916 and 918, respectively, which extend beyond the spaced rails. The bogey further includes four wheels as at 920. A pair of spaced trackside guideways are situated just outside and extending along parallel to the rails 914, together with a pair of dog carriages 926 and 928, respectively, carrying high pusher dogs 930 and 932 which are shown in the raised position addressing the spaced frame sides 916 and 918, respectively, contacting them above the level of an axle 934. The dog carriages 926 and 928 are operated by reciprocating, serially connected or tandem hydraulic cylinders which may consist of four cylinders, and operate in series to move the carriages along the corresponding guideways. The bogey frame detecting and dog-operating system.

1. A terminal, comprising:
a railcar transfer apparatus, the railcar transfer apparatus configured to move a railcar at least in a direction generally normal to a length of the railcar.

2. The terminal of claim 1, further comprising:
a terminal building comprising a hollow interior and a wall comprising a first plurality of dock bays; and
rail track segments, each rail track segment from the rail track segments connecting a respective dock bay to the railcar transfer apparatus.

3. (canceled)

4. (canceled)

5. (canceled)

6. (canceled)

7. The terminal of claim 2, wherein the terminal building comprises a railcar restraint.

8. The terminal of claim 7, wherein the railcar restraint comprises:
a rail coupler; and
a linear actuator connected to the rail coupler, the linear actuator configured to move, with a movable portion, the rail coupler in a linear direction.

9. (canceled)

10. The terminal of claim 8, further comprising a draft gear mounted mediate the rail coupler and the linear actuator.

11. The terminal of claim 8, wherein the rail coupler comprises:
a coupler shank;
a coupler head having a knuckle side and a guard arm side;
a knuckle pin mounted within the coupler head; and
a coupler knuckle which is mounted for independent rotation on a knuckle pin.

12. The terminal of claim 11, further comprising a cut lever apparatus operable to remotely unlock the coupler knuckle.

13. (canceled)

14. (canceled)

15. The terminal of claim 7, wherein the railcar restraint comprises a rail track segment inclined downwardly from the railcar transfer apparatus toward the terminal building.

16. (canceled)

17. (canceled)

18. The terminal of claim 1, further comprising a railcar staging area.

19. (canceled)

20. (canceled)

21. (canceled)

22. (canceled)

23. (canceled)

24. (canceled)

25. (canceled)

26. (canceled)

27. (canceled)

28. (canceled)

29. The terminal of claim 1, further comprising:
a terminal building comprising a hollow interior and a plurality of loading docks along a wall of the terminal building;
rail track segments, each rail track segment from the rail track segments connecting a respective dock bay to the railcar transfer apparatus;
a first rail track at one end of the terminal building; and
a second rail track at an opposite end of the terminal building;
the railcar transfer apparatus being in a railcar exchange with each of the terminal building, the first rail track and the second rail track.

30. The terminal of claim 1, wherein the railcar transfer apparatus comprises:
two rail tracks disposed, at a distance, parallel to each other, each rail track having two rails spaced at a distance from each other to align with bogey wheels of a railcar;
a railcar transfer bridge comprising:
a frame,
a propulsion designed to move the railcar transfer bridge on the two rail tracks, and
two rail track portions disposed on the frame; and
a self-propelled railcar mover designed to move a railcar onto and from the railcar transfer bridge.

31. (canceled)

32. The terminal of claim 1, wherein the railcar transfer apparatus comprises an oval-shaped rail track.

33. The terminal of claim 1, wherein the railcar transfer apparatus comprises an automated rotating transfer arm.

34. The terminal of claim 1, wherein the railcar transfer apparatus comprises an automated rotating transfer carousel.

35. The terminal of claim 1, wherein the railcar transfer apparatus comprises an automated transfer shuttle or bridge, the automated transfer shuttle or bridge comprising:
four wheeled bogeys;
a drive motor attached to one wheeled bogey from the four wheeled bogeys;
a controller;
a power source;
a frame supported on four wheeled bogeys; and
two rail track segments disposed, at a distance from each other, on the frame.

36. The terminal of claim 1, wherein the railcar transfer apparatus comprises an automated guided vehicle.

37. (canceled)

38. (canceled)

39. (canceled)

40. (canceled)

41. (canceled)

42. (canceled)

43. (canceled)

44. The terminal of claim 1, wherein the railcar transfer apparatus comprises:
two wheeled bogeys disposed at a distance from each other;
two drive motors, each drive motor disposed on one wheeled bogey from the two wheeled bogeys;
a platform attached to the two wheeled bogeys; and
a rail track portion disposed on the platform to receive wheels of the railcar;
the railcar transfer apparatus remotely operable to align the rail track portion with a rail track in a railcar staging.

45. (canceled)

46. (canceled)

47. (canceled)

48. The terminal of claim 1, wherein the railcar transfer apparatus comprises an automated transfer shuttle and an automated railcar mover.

49. The terminal of claim 48, wherein the automated transfer shuttle comprises:
two wheeled bogeys disposed at a distance from each other;
two drive motors, each drive motor disposed on one wheeled bogey from the two wheeled bogeys;
a controller;
a power source;
a platform attached to the two wheeled bogeys; and
two rail track portions disposed on the platform at a distance from each other to receive wheels of the railcar.

50. The terminal of claim 48, wherein the automated railcar mover comprises:
two wheel sets disposed at a distance from each other
a drive motor coupled to one wheel set from the two wheel sets;
a controller;
a power source;
a frame supported on the two wheel sets; and
a rail coupler with a coupler knuckle and a coupler shank, the coupler knuckle extending outwardly from the frame.

51. The terminal of claim 48, wherein the automated railcar mover comprises:
two wheel sets disposed at a distance from each other
a drive motor coupled to one wheel set from the two wheel sets;
a power source;
a frame supported on the two wheel sets;
a driver cab mounted on the frame, the driver cab configured with controls to control, by a driver, an operation of the automated railcar mover; and
a rail coupler with a coupler knuckle and a coupler shank, the coupler knuckle extending outwardly from the frame.

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)
